(19) United States
(12) Patent Application Publication
(10) Pub. No.: US 2024/0193886 A1
(43) Pub. Date: Jun. 13, 2024

(54) TECHNIQUES FOR GENERATING A DIGITAL REPRESENTATION OF A PROPERTY AND APPLICATIONS THEREOF

(71) Applicant: Wayfair LLC, Boston, MA (US)

(72) Inventors: Shrenik Sadalgi, Cambridge, MA (US); Steven Conine, Boston, MA (US); Nicole Allison Tan, Brookline, MA (US)

(73) Assignee: Wayfair LLC, Boston, MA (US)

(21) Appl. No.: 18/288,127

(22) PCT Filed: Apr. 29, 2022
(86) PCT No.: PCT/US2022/027075

§ 371 Date: Oct. 24, 2023

Related U.S. Application Data
(60) Provisional application No. 63/221,433, filed on Jul. 13, 2021.
(60) Provisional application No. 63/182,546, filed on Apr. 30, 2021.

(51) Int. Cl. G06T 19/20; G06T 7/70

(52) U.S. Cl. CPC G06T 19/20; G06T 7/70; G06T 2219/2004; G06T 2219/2012; G06T 2219/2016

(57) ABSTRACT

Method and systems for generating, storing, and using a digital representation of a property are provided. The digital representation of the property may include a property profile comprising information associated with an address of the property, the property profile comprising multiple digital representations of multiple respective indoor and/or outdoor spaces of the property and a user profile comprising metadata associated with an owner and/or an occupant of the property. The digital representation of the property may be used in various applications including shopping (e.g., shopping for products, like furniture, which may be purchased for use in the property), provisioning of services for the property (e.g., design services, contractor services, etc.), and various other applications.

### CROSS-REFERENCE TO RELATED APPLICATIONS

This application claims the benefit of priority under 35 U.S.C. 119(e) to U.S. Provisional Patent Application Ser. No. 63/221,433, filed on Jul. 13, 2021, titled “Techniques For Generating A Digital Representation Of A Property And Applications Thereof”, and U.S. Provisional Patent Application Ser. No. 63/182,546, filed on Apr. 30, 2021, titled “Techniques For Generating A Digital Representation Of A Home And Applications Thereof,” which are hereby incorporated by reference herein in their entirety.

### BACKGROUND

More and more users are utilizing online platforms for various home-related activities. For example, users access online retailer websites to purchase products for their home. As another example, users access real estate websites to view video tours of homes they might be interested in buying. As another example, users may access service provider websites to determine whether to hire a particular service provider for a home project.

### SUMMARY

Some embodiments provide for a method, comprising using at least one computer hardware processor to perform: accessing a digital representation of a property, the property comprising a plurality of spaces including a first space, the digital representation comprising multiple digital representations of multiple respective spaces in the plurality of spaces, the multiple digital representations including a first digital representation of the first space, the first digital representation comprising: first spatial data specifying dimensions of the first space; and first imagery associated with the first space; generating, using the digital representation of the property, an interactive user interface that allows a user to perform one or more actions with respect at least one of the multiple spaces, the generating comprising: generating a visualization of the first space using the first spatial data and the first imagery; and causing the interactive user interface to be presented to the user.

Some embodiments provide for a system comprising: at least one computer hardware processor; and at least one non-transitory computer-readable storage medium storing processor-executable instructions that, when executed by the at least one computer hardware processor, cause the at least one computer hardware processor to perform: accessing a digital representation of a property, the property comprising a plurality of spaces including a first space, the digital representation comprising multiple digital representations of multiple respective spaces in the plurality of spaces, the multiple digital representations including a first digital representation of the first space, the first digital representation comprising: first spatial data specifying dimensions of the first space; and first imagery associated with the first space; generating, using the digital representation of the property, an interactive user interface that allows a user to perform one or more actions with respect at least one of the multiple spaces, the generating comprising: generating a visualization of the first space using the first spatial data and the first imagery; and causing the interactive user interface to be presented to the user.

Some embodiments provide for at least one non-transitory computer-readable storage medium storing processor-executable instructions that, when executed by at least one computer hardware processor, cause the at least one computer hardware processor to perform: accessing a digital representation of a property, the property comprising a plurality of spaces including a first space, the digital representation comprising multiple digital representations of multiple respective spaces in the plurality of spaces, the multiple digital representations including a first digital representation of the first space, the first digital representation comprising: first spatial data specifying dimensions of the first space; and first imagery associated with the first space; generating, using the digital representation of the property, an interactive user interface that allows a user to perform one or more actions with respect at least one of the multiple spaces, the generating comprising: generating a visualization of the first space using the first spatial data and the first imagery; and causing the interactive user interface to be presented to the user.

Some embodiments provide for a method for generating a digital representation of a property, the property comprising a plurality of indoor and/or outdoor spaces, the method comprising: using at least one computer hardware processor to perform: obtaining spatial data associated with the plurality of indoor and/or outdoor spaces; obtaining imagery associated with the plurality of indoor and/or outdoor spaces; generating the digital representation of the property based on the obtained spatial data and imagery, the digital representation comprising: a property profile comprising information associated with an address of the property, the property profile comprising multiple digital representations of multiple respective indoor and/or outdoor spaces of the plurality of indoor and/or outdoor spaces, and a user profile comprising metadata associated with an owner and/or an occupant of the property; and storing the digital representation of the property in association with the address of the property.

Some embodiments provide for a system for generating a digital representation of a property, the property comprising a plurality of indoor and/or outdoor spaces, the system comprising: at least one computer hardware processor; and at least one non-transitory computer-readable storage medium storing processor-executable instructions that, when executed by the at least one computer hardware processor, cause the at least one computer hardware processor to perform: obtaining spatial data associated with the plurality of indoor and/or outdoor spaces; obtaining imagery associated with the plurality of indoor and/or outdoor spaces; generating the digital representation of the property based on the obtained spatial data and imagery, the digital representation comprising: a property profile comprising information associated with an address of the property, the property profile comprising multiple digital representations of multiple respective indoor and/or outdoor spaces of the plurality of indoor and/or outdoor spaces, and a user profile comprising metadata associated with an owner and/or an occupant of the property; and storing the digital representation of the property in association with the address of the property.

Some embodiments provide for at least one non-transitory computer-readable storage medium storing processor-executable instructions that, when executed by the at least one computer hardware processor, cause the at least one computer hardware processor to perform a method for generating a digital representation of a property, the property comprising a plurality of indoor and/or outdoor spaces, the method comprising: obtaining spatial data associated with the plurality of indoor and/or outdoor spaces; obtaining imagery associated with the plurality of indoor and/or outdoor spaces; generating the digital representation of the property based on the obtained spatial data and imagery, the digital representation comprising: a property profile comprising information associated with an address of the property, the property profile comprising multiple digital representations of multiple respective indoor and/or outdoor spaces of the plurality of indoor and/or outdoor spaces, and a user profile comprising metadata associated with an owner and/or an occupant of the property; and storing the digital representation of the property in association with the address of the property.

Some embodiments provide for a method, comprising using at least one computer hardware processor to perform: accessing a digital representation of a property, the property comprising a plurality of spaces, the digital representation comprising multiple digital representations of multiple respective spaces in the plurality of spaces, wherein accessing the digital representation of the property comprises: obtaining authentication information for a user; and determining, using the authentication information, whether the user is authorized to access the digital representation of the property; in response to determining that the user is authorized the access the digital representation of the property: generating, using the digital representation of the property, an interactive user interface that allows the user to perform one or more actions with respect at least one of the multiple spaces, the interactive user interface comprising a visualization of a first space of the multiple spaces; obtaining, based on user input provided through the interactive user interface, an indication of a first product and a first position in the visualization of the first space at which to insert a visualization of the first product; and updating the visualization of the first space to include the visualization of the first product at the first position.

Some embodiments provide for a system, comprising: at least one computer hardware processor; and at least one non-transitory computer-readable storage medium storing processor-executable instructions that, when executed by the at least one computer hardware processor, cause the at least one computer hardware processor to perform: accessing a digital representation of a property, the property comprising a plurality of spaces, the digital representation comprising multiple digital representations of multiple respective spaces in the plurality of spaces, wherein accessing the digital representation of the property comprises: obtaining authentication information for a user; and determining, using the authentication information, whether the user is authorized to access the digital representation of the property; in response to determining that the user is authorized the access the digital representation of the property: generating, using the digital representation of the property, an interactive user interface that allows a user to perform one or more actions with respect at least one of the multiple spaces, the interactive user interface comprising a visualization of a first space of the multiple spaces; obtaining, based on user input provided through the interactive user interface, an indication of a first product and a first position in the visualization of the first space at which to insert a visualization of the first product; and updating the visualization of the first space to include the visualization of the first product at the first position.

Some embodiments provide for a method, comprising using at least one computer hardware processor to perform: obtaining spatial data associated with a plurality of indoor and/or outdoor spaces of a property; obtaining imagery associated with the plurality of indoor and/or outdoor spaces; identifying a plurality of objects in the plurality of indoor and/or outdoor spaces using the spatial data and the imagery, wherein identifying a plurality of objects comprises identifying a set of objects in a first space of the plurality of indoor and/or outdoor spaces; identifying, using product information in a product database, a set of products corresponding to the set of objects; generating a digital representation of the property based on the spatial data and imagery, the digital representation comprising a first digital representation of the first space, the first digital representation comprising: first spatial data specifying dimensions of the first space; and first imagery associated with the first space; and generating a visualization of the first space using the first spatial data and the first imagery, wherein generating the visualization of the first space comprises generating the visualization of the first space by displaying, for each particular object of the set of objects, an image or 3D model of the corresponding product in the set of products, instead of the particular object.

Some embodiments provide for at least one non-transitory computer-readable storage medium storing processor-executable instructions that, when executed by the at least one computer hardware processor, cause the at least one computer hardware processor to perform: accessing a digital representation of a property, the property comprising a plurality of spaces, the digital representation comprising multiple digital representations of multiple respective spaces in the plurality of spaces, wherein accessing the digital representation of the property comprises: obtaining authentication information for a user; and determining, using the authentication information, whether the user is authorized to access the digital representation of the property; in response to determining that the user is authorized the access the digital representation of the property: generating, using the digital representation of the property, an interactive user interface that allows the user to perform one or more actions with respect at least one of the multiple spaces, the interactive user interface comprising a visualization of a first space of the multiple spaces; obtaining, based on user input provided through the interactive user interface, an indication of a first product and a first position in the visualization of the first space at which to insert a visualization of the first product; and updating the visualization of the first space to include the visualization of the first product at the first position.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 is an example system configured to generate and store digital representations of properties, according to some embodiments of the technology described herein;

FIG. 2A illustrates example contents of a digital representation of a property, according to some embodiments of the technology described herein;

FIG. 2B illustrates example contents of a property profile included in the digital representation of FIG. 2A, according to some embodiments of the technology described herein;

FIG. 2C illustrates example contents of a user profile included in the digital representation of FIG. 2A, according to some embodiments of the technology described herein;

FIGS. 2D-2F illustrate example data structures for storing contents of the property profile of FIG. 2B and/or user profile of FIG. 2C, according to some embodiments of the technology described herein;

FIGS. 2G-2J illustrates example databases with which some embodiments of the technology described herein may operate;

FIG. 3A is a flowchart of an example process for creating and storing a digital representation of a property, according to some embodiments of the technology described herein;

FIG. 3B is a flowchart of an example process for accessing and using a digital presentation of a property, according to some embodiments of the technology described herein;

FIG. 3C is a flow diagram of an example process for accessing a digital representation of a property for collaboration between users of the system of FIG. 1, according to some embodiments of the technology described herein;

FIG. 3D is a flowchart of an example process for accessing and using a digital presentation of a property, according to some embodiments of the technology described herein;

FIG. 4A is an example three-dimensional digital representation of a property, according to some embodiments of the technology described herein;

FIG. 4B illustrates example visualization layers that include information for generating visualizations of a property, according to some embodiments of the technology described herein;

FIG. 5 is an example screen capture of an interactive user interface that allows a user to access a digital representation of a property, according to some embodiments of the technology described herein;

FIG. 6 is an example screen capture of an interactive user interface that allows a user to view and interact with visualizations of spaces in a property, according to some embodiments of the technology described herein;

FIG. 7 is another example screen capture of an interactive user interface that allows a user to view and interact with visualizations of spaces in a property, according to some embodiments of the technology described herein;

FIGS. 8A-8D are example screen captures of an interactive user interface that allows a user to update digital representations of spaces in a property, according to some embodiments of the technology described herein;

FIGS. 9A-9B are additional example screen captures of an interactive user interface that allows a user to update digital representations of spaces in a property, according to some embodiments of the technology described herein;

FIG. 10 is an example screen capture of an interactive user interface that allows a user to initiate a product browsing session, according to some embodiments of the technology described herein;

FIGS. 11A-11B are example screen captures of an interactive user interface that allows a user to visualize products in visualizations of spaces in a property, according to some embodiments of the technology described herein;

FIGS. 12A-12C are example screen captures of an interactive user interface that allows a user to visualize different products at a same position in a visualization of a space in a property, according to some embodiments of the technology described herein;

FIGS. 13A-13D are example screen captures of an interactive user interface that allows a user to purchase a product, indicate a location in a visualization of a space in a property at which to position the purchased product, and indicate a delivery path through the property for the purchased product, according to some embodiments of the technology described herein;

FIG. 14 is an example screen capture of an interactive user interface that allows a user to collaborate with other users of the system, according to some embodiments of the technology described herein;

FIGS. 15A-15D are additional example screen captures of an interactive user interface that allow a user to collaborate with other users of the system, according to some embodiments of the technology described herein;

FIG. 16 is an example screen capture of an interactive user interface that allows a user to collaborate with partner enterprises, according to some embodiments of the technology described herein;

FIGS. 17A-17B are additional example screen captures of an interactive user interface that allow a user to collaborate with partner enterprises, according to some embodiments of the technology described herein;

FIG. 18 is a block diagram of an example computer system, according to some embodiments of the technology described herein.

### DETAILED DESCRIPTION

A large amount of data exists for a given property. Examples of data about a property may include, but are not limited to, images of the property (e.g., images of the outside and/or the inside of the property), blueprints or floor plans of the property, information about objects in the property (e.g., furnishings, fixtures, appliances, etc.), tax history associated with the property, permits and/or official records for the property, ownership history for the property, sales/price history for the property, information about services or service providers servicing the property, information about consumables (e.g., air/water filters, HVAC filters, etc.) needed in the property, information about liens on the property, information about historic utility usage for the property, information about fuel/energy usage for the property, an energy assessment for the property, information about maintenance history for the property (e.g., history about when new roof or siding was installed or particular renovations for particular spaces were performed), information about solar energy generation capability for the property, information about systems installed in the property (security systems, lighting systems, HVAC systems, etc.), landscaping information (e.g., trees, shrubs, grass, pool, etc.), insurance information (e.g., history, claims, quotes, etc.), property owner's association information if applicable (e.g., emergency contacts, bylaws, fees, etc.), information about cameras installed in the property (e.g., video feeds, location of camera, type of camera), information about people who have worked on/in the property (e.g., contractors, designers, landscapers, etc.), and/or other data.

Although a lot of data exists for a given property, these data are stored in different and disparate locations, often not in an electronic format, which makes these data difficult to access and use. For example, some data about a property (e.g., ownership records, sales records, deeds, permits, easements, property boundaries, tax information, utility information, inspection certificates, etc.) may be maintained by a town or city in which the property is located and may be accessible either in a paper file or through accessing a data management system maintained by the town or city. As another example, some data about a property (e.g., images, sales history, facts about a property) may be available on one or more publicly or privately accessible databases such as multiple listing service (MLS) or other real estate databases. As another example, some data about a property may be maintained by a property owner in the property (e.g., storage cabinets and drawers may contain manuals for appliances and fixtures, tax information, ownership records, etc.), the property owner's devices (e.g., images of the property stored in the owner's smartphone, contact information for service providers such as landscapers, electricians, plumbers, etc.) or even just in the property owner's mind (or in the mind of a resident or occupant of the property, where the owner doesn't reside in the property or is not the sole resident of the property). All these data are not available through a single source of information, may not be stored electronically, and are difficult to obtain.

Moreover, even where some of the data about a property is stored in an electronic format, different data repositories have different accessibility requirements such that a single user or a software application may not have sufficient access privileges to access all these data. For example, some data about a property may be accessible only to a current property owner. As another example, some data about a property may be accessible only by paying for subscription access to a curated database, which is otherwise not publicly accessible. As another example, some data about a property may be accessible only through MLS, which is accessible only by real estate professionals. As another example, although the publicly available data remains accessible via the conventional property data management systems when a current property owner sells the property, much of the data maintained by the current property owner is not transferred to a new property owner during or after the selling process.

The inventors have recognized that conventional property data management systems simply do not provide access to all these types of data about a property. Existing property data management systems are built for ad hoc purposes, but generally do not provide information about, provide access to, or allow for interaction with, aspects of the property (e.g., non-public data) that only a current property owner may be privy to. For example, conventional data management systems exist to facilitate real estate transactions and, to this end, allow users to view images of a property and spaces within the property. However, such data management systems do not provide access to many other types of data about a property including, for example, information about positions of objects (e.g., furnishings, appliances, fixtures, etc.) in the property, information about services or service providers servicing the property, information about consumables needed in the property, information about systems installed in the property (security systems, lighting systems, HVAC systems, etc.), landscaping information (e.g., trees, shrubs, grass, pool, etc.), energy assessment information, maintenance history information, and/or other data.

In addition, such conventional systems are limited in the type of actions that they allow users to perform beyond merely viewing imagery. While some such conventional systems may allow user selection of multiple viewpoints and generate renderings from the selected viewpoints, they do not allow users to perform actions with respect to objects in the property. For example, these systems do not allow a user to perform actions indicating updates to positions of existing structural elements (e.g., walls) and/or objects (e.g., furniture) in visualizations of spaces of a property. A visualization of the space may include visualizations of the objects (e.g., visualization of two-dimensional (2D) or three-dimensional (3D) models of the objects) in the space. The user may interact with these object visualizations by changing the position/rearranging the object visualizations (e.g., rearranging 3D models of furniture items in the living room) within the space. The conventional systems also do not allow a user to add new objects in the space (e.g., add a 3D model of a couch in a living room), visualize different objects in the same portion of the space (e.g., view 3D models of different couches in a specified position in a living room), manipulate existing structural elements (e.g., by moving walls), and/or perform other actions.

The inventors have recognized and appreciated that conventional property data management systems can be improved by providing a technology platform that not only stores various types of data (public and non-public data) associated with properties, but also provides a digital representation of a property that a user may interact with to perform various actions with respect to spaces in the properties.

The inventors have developed a technology platform that implements techniques for generating, storing, and using a digital representation of a property. A property may be any suitable type of property into which furnishings, appliances, fixtures, and/or fittings may be placed. For example, a property may be a home, an apartment, an office building, a restaurant, a hotel, a store, a shopping center, and/or any other property with furnishings, appliances, and/or fixtures and fittings. In some embodiments, a property may include one building (e.g., a single-family home) or multiple buildings (e.g., multiple homes on one plot of land). In some embodiments, a property may be part of one building (e.g., an apartment in an apartment building, a store in a shopping mall, a restaurant occupying a floor of a building, an office for a company occupying one or more floors, or a part of a floor, in a building, etc.). In some embodiments, a property may include one or more buildings under shared corporate ownership or franchising agreements. In some embodiments, a home may include a single family detached house, an apartment, a bungalow, a cabin, a condominium, a townhome, a villa, a mobile home, or any other type of home.

The digital representation of the property may include a two-dimensional (2D) or three-dimensional (3D) representation of the property. The digital representation of the property may include public and non-public data associated with the property. The digital representation may be generated using spatial data and/or imagery associated with the property and may represent a digital “twin” of the property that can be viewed, controlled, and interacted with via the platform. The technology platform enables using the digital representation of the property in various applications including shopping (e.g., shopping for products, like furniture, which may be purchased for use in the property), provisioning of services for the property (e.g., design services, contractor services, etc.), and various other applications examples of which are provided herein. The technology platform enables using the digital representation of the property to provide better visualizations of the property/spaces of the property, smarter recommendations for products or services for the property/spaces of the property, and/or easier ways to collaborate with different users (e.g., designers, contractors, etc.) on various property-related projects (e.g., renovations, irrigation system, sound system or lighting system installations, etc.).

In some embodiments, a digital representation of a property may be generated and stored. The property, such as a home, may include a plurality of indoor and/or outdoor spaces (e.g., bedroom, living room, office, kitchen, patio, porch, etc.). The digital representation of the property may be generated and stored by: (1) obtaining spatial data (e.g., data specifying dimensions, 3D representations) associated with the plurality of indoor and/or outdoor spaces; (2) obtaining imagery (e.g., images) associated with the plurality of indoor and/or outdoor spaces; (3) generating the digital representation of the property based on the obtained spatial data and imagery; and (4) storing the digital representation of the property in association with an address of the property. In some embodiments, the digital representation of the property may include a property profile and a user profile. The property profile may include information associated with the address of the property, for example, the property profile may include multiple digital representations of multiple respective indoor and/or outdoor spaces of the plurality of indoor and/or outdoor spaces. The user profile may include metadata associated with an owner and/or an occupant of the property.

In some embodiments, the digital representation of the property may be accessed to generate visualizations of the multiple indoor and/or outdoor spaces in the property and allow users to interact with and perform various actions with respect to the spaces. Digital representations of the spaces may each include spatial data specifying dimensions of the respective space and imagery associated with the respective space. In some embodiments, an interactive user interface may be generated using the digital representation of the property. The interactive user interface allows users to interact with and perform various actions with respect to the spaces. In some embodiments, generating the interactive user interface may include (1) generating visualizations of spaces using the spatial data and imagery associated with the spaces; and (2) causing the interactive user interface to be presented to the user.

Accordingly in some embodiments, a method is provided where at least one computer hardware processor is used to perform: (1) accessing a digital representation of a property, the property comprising a plurality of spaces including a first space, the digital representation comprising multiple digital representations of multiple respective spaces in the plurality of spaces, the multiple digital representations including a first digital representation of the first space, the first digital representation comprising: first spatial data specifying dimensions of the first space; and first imagery associated with the first space; (2) generating, using the digital representation of the property, an interactive user interface that allows a user to perform one or more actions with respect at least one of the multiple spaces, the generating comprising: generating a visualization of the first space using the first spatial data and the first imagery; and causing the interactive user interface to be presented to the user.

In some embodiments, the plurality of spaces includes a second space different from the first space, the multiple digital representations include a second digital representation of the second space. The second digital representation comprises second spatial data specifying dimensions of the second space and second imagery associated with the second space. In some implementations, generating the interactive user interface comprises generating a visualization of the second space using the second spatial data and the second imagery.

In some embodiments, the first spatial data comprises a three-dimensional (3D) representation of the first space.

In some embodiments, the 3D representation of the first space comprises data collected by performing a 3D scan of the first space.

In some embodiments, each of the multiple digital representations comprises data collected by performing a 3D scan of a respective one of the multiple spaces.

In some embodiments, the first imagery comprises one or more images of the first space obtained using one or more optical sensors.

In some embodiments, the first imagery comprises one or more synthetic images of the first space, the one or more synthetic images generated in accordance with the first spatial data.

In some embodiments, the first space is an indoor room in the property, the first spatial data comprises a 3D representation of the indoor room, and the 3D representation generated using data collected by performing a 3D scan of the indoor room.

In some embodiments, the first digital representation of the first space comprises information specifying one or more positions of one or more objects in the first space.

In some embodiments, the one or more objects include one or more pieces of furniture, one or more wall coverings, one or more floor coverings, one or more fixtures, and/or one or more appliances.

In some embodiments, the first spatial data comprises data obtained by performing a 3D scan of the one or more objects in the first space.

In some embodiments, the first digital representation comprises metadata associated with a first of the one or more objects, the metadata including information selected from the group consisting of: information identifying the first object; information identifying characteristics of the first object; information containing feedback about the first object from one or more other users different from the user; information indicating a price of the first object; information indicating a source for the first object; and information indicating one or more specifications for the first object.

In some embodiments, the digital representation of the property comprises a property profile comprising information associated with an address of the property, the property profile comprising the multiple digital representations of the multiple respective spaces; and a user profile comprising metadata associated with an owner and/or an occupant of the property.

In some embodiments, the interactive user interface comprises an augmented reality (AR) interface; and causing the interactive user interface to be presented to the user comprises causing the AR interface to be presented to the user.

In some embodiments, the interactive user interface comprises a virtual reality (VR) interface; and causing the interactive user interface to be presented to the user comprises causing the VR interface to be presented to the user.

In some embodiments, accessing the digital representation of the property comprises obtaining authentication information for the user; and determining, using the authentication information, whether the user is authorized to access the digital representation of the property.

In some embodiments, the method further comprises receiving, via the interactive user interface, user input indicating an update to be made to the digital representation of the property; and updating the digital representation of the property based on the user input; and storing the updated digital representation.

In some embodiments, the update is to be made to the first digital representation of the first space in the property and the update comprises an update to the first spatial data. The update to the first spatial data comprises an update to the dimensions of the first space; an update to 3D data for the first space; an update to one or more positions of one or more objects in the first space; and/or an indication to add a new object in the first space at a specified position.

In some embodiments, the update to the first spatial data comprises the update to the one or more positions of the one or more objects in the first space, the one or more objects comprises a plurality of pieces of furniture, and the update represents a re-arrangement of the plurality of pieces of furniture in the first space.

In some embodiments, the update is to be made to the first digital representation of the first space in the property, and the update comprises an update to the first imagery. The update to the first imagery comprises an indication to change an existing image of the first space to another image; and/or an indication to include a new image of the first space in the first digital representation.

In some embodiments, the interactive user interface comprises a product browsing interface that allows the user to see information about one or more products. In some implementations, the method further comprises obtaining, based on first user input provided through the interactive user interface, an indication of a first product and a first position in the visualization of the first space at which to insert a visualization of the first product; and updating the visualization of the first space to include the visualization of the first product at the first position.

In some embodiments, the method further comprises obtaining, based on second user input provided through the interactive user interface, an indication of a second product; and updating the visualization of the first space to include the visualization of the second product at the first position.

In some embodiments, the method further comprises obtaining, based on third user input provided through the interactive user interface, an indication of a third product; and updating the visualization of the first space to include the visualization of the third product at the first position.

In some embodiments, the method further comprises obtaining, via the interactive user interface, user input indicating that the user is purchasing the first product.

In some embodiments, the method further comprises obtaining, via the interactive user interface, information indicating a position in the first space at which to place the first product when the first product is delivered to the property.

In some embodiments, the method further comprises obtaining, via the interactive user interface, information indicating at least a part of a path through the property that the first product is to be moved through in order to be delivered to the property and placed at the first position in the first space.

In some embodiments, the digital representation of the property comprises a user profile comprising information about the user, the user profile containing information about the user's product preferences. In some implementations, the method further comprises identifying at least one product based on the information and the user's product preferences; and providing information about the at least one product to the user via the product browsing interface.

In some embodiments, the method further comprises identifying at least one product based on the first spatial data; and providing information about the at least one product to the user via the product browsing interface.

In some embodiments, identifying the at least one product based on the first spatial data comprises identifying the at least one product based on the first spatial data associated with the first space and second spatial data associated with a second space different from the first space, the second spatial data specifying dimensions of the second space and/or dimensions of means of ingress and/or egress for entering and/or exiting the second space.

In some embodiments, the second space is selected from at least one of a hallway, entryway, doorway, corridor, entrance, and stairway, and the means of ingress and/or egress is selected from at least one of a door and window.

In some embodiments, the method further comprises identifying at least one product based on information about style of one or more objects in the first space; and providing information about the at least one product to the user via the product browsing interface.

In some embodiments, the method further comprises generating, using the digital representation of the property, a second interactive user interface for a second user, different from the user. In some implementations, the generating comprises generating a second visualization of the first space using the first spatial data and the first imagery; and causing the second interactive user interface to be presented to the second user.

In some embodiments, the method further comprises obtaining input provided by the second user via the second interactive user interface, the input indicative of information related to content of the second visualization; and causing the information to be presented to the first user in the first interactive user interface.

In some embodiments, the information comprises one or more of a comment, a message, a question, an emoji, an estimate, a quote, and a bid.

In some embodiments, the method further comprises obtaining input provided by the second user via the second interactive user interface, the input indicative of an action to perform with respect to the second visualization; and updating the visualization at least in part by performing the action indicated in the input provided by the second user.

In some embodiments, the action to perform with respect to the second visualization comprises one or more of: an update to one or more positions of one or more pieces of furniture, fixtures, and/or appliances in the first space, an addition of a new piece of furniture, a new fixture, and/or a new appliance in the first space at a specified position, an update to one or more wall coverings or floor coverings in the first space, and an update to a color of one or more walls in the first space.

In some embodiments, generating the second interactive user interface comprises generating a plurality of visualizations of the first space for the second user using the first spatial data and the first imagery, the plurality of visualizations including the second visualization, each of the plurality of visualizations indicating a different layout of objects in the first space.

According to some embodiments, a method for generating a digital representation of a property comprising a plurality of indoor and/or outdoor spaces may be provided, where at least one computer hardware processor may be used to perform: (1) obtaining spatial data associated with the plurality of indoor and/or outdoor spaces; (2) obtaining imagery associated with the plurality of indoor and/or outdoor spaces; (3) generating the digital representation of the property based on the obtained spatial data and imagery, the digital representation comprising: a property profile comprising information associated with an address of the property, the property profile comprising multiple digital representations of multiple respective indoor and/or outdoor spaces of the plurality of indoor and/or outdoor spaces, a user profile comprising metadata associated with an owner and/or an occupant of the property; and (4) storing the digital representation of the property in association with the address of the property.

According to some embodiments, a method may be provided, where at least one computer hardware processor may be used to perform: (1) accessing a digital representation of a property, the property comprising a plurality of spaces, the digital representation comprising multiple digital representations of multiple respective spaces in the plurality of spaces, wherein accessing the digital representation of the property comprises: obtaining authentication information for a user; and determining, using the authentication information, whether the user is authorized to access the digital representation of the property; (2) in response to determining that the user is authorized the access the digital representation of the property: generating, using the digital representation of the property, an interactive user interface that allows a user to perform one or more actions with respect at least one of the multiple spaces, the interactive user interface comprising a visualization of a first space of the multiple spaces; (3) obtaining, based on user input provided through the interactive user interface, an indication of a first product and a first position in the visualization of the first space at which to insert a visualization of the first product; and (4) updating the visualization of the first space to include the visualization of the first product at the first position.

According to some embodiments, a method may be provided, where at least one computer hardware processor may be used to perform: (1) obtaining spatial data associated with a plurality of indoor and/or outdoor spaces of a property; (2) obtaining imagery associated with the plurality of indoor and/or outdoor spaces; (3) identifying a plurality of objects in the plurality of indoor and/or outdoor spaces using the spatial data and the imagery, wherein identifying a plurality of objects comprises identifying a set of objects in a first space of the plurality of indoor and/or outdoor spaces; (4) identifying, using product information in a product database, a set of products corresponding to the set of objects; (5) generating a digital representation of the property based on the spatial data and imagery, the digital representation comprising a first digital representation of the first space, the first digital representation comprising: first spatial data specifying dimensions of the first space; and first imagery associated with the first space; and (6) generating a visualization of the first space using the first spatial data and the first imagery, wherein generating the visualization of the first space comprises generating the visualization of the first space by displaying, for each particular object of the set of objects, an image or 3D model of the corresponding product in the set of products, instead of the particular object.

In some embodiments, the set of objects comprises a first object, identifying the set of products comprises identifying a first product corresponding to the first object, and identifying the first product comprises comparing an image or 3D model of the first object with one or more images or 3D models of products in the product database; and determining whether the image or 3D model of the first object matches at least one of the one or more images or 3D models of the products in the database.

In some embodiments, identifying the set of products comprises identifying either a product that matches or is similar to the object based on the comparing.

In some embodiments, generating the visualization of the first space comprises substituting the object in the visualization with an image or 3D model of either the product that matches or is similar to the object

### Example Systems

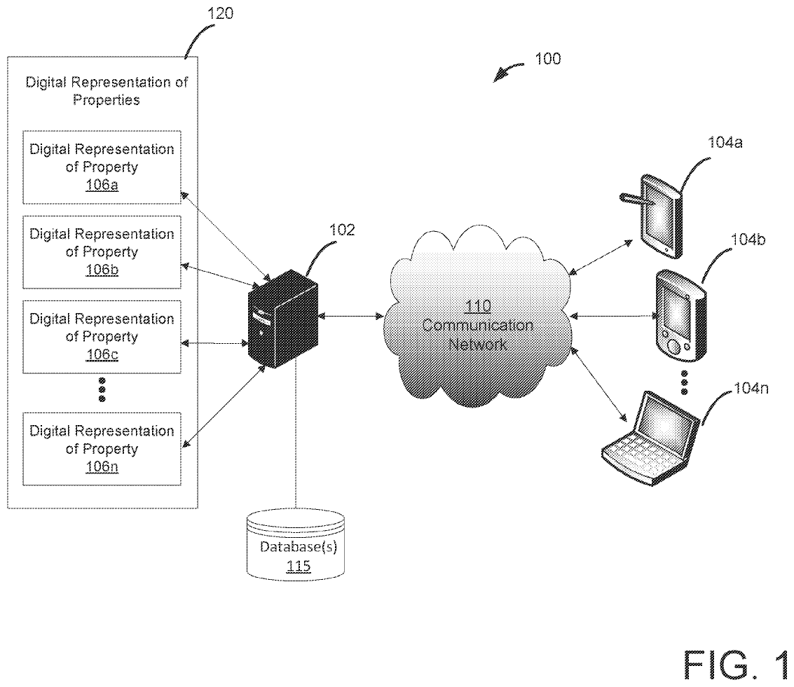

FIG. 1 shows an illustrative implementation of the above-described technology platform as system 100 that is configured to generate and store digital representations of properties. System 100 may include a server computing device 102 that is configured to obtain spatial data and imagery associated with one or more properties from multiple client computing devices 104a, 104b, . . . , 104n via communication network 110. A client computing device 104a, 104b, . . . , 104n may include a mobile computing device, such as, a user's mobile smartphone, tablet computer, AR headset, a laptop computer or other mobile computing device.

In some embodiments, server computing device 102 may obtain spatial data and imagery associated with multiple spaces in a property. A space may be an indoor space inside of a property, such as a room or hallway, or an outdoor space outside the property, such as a yard or porch. For example, a space in a home may be a front yard, a back yard, a side yard, a porch, a garage, a living room, a bedroom, a kitchen, a bathroom, a dining room, a family room, a basement, an attic, a closet, a laundry room, a foyer, a hallway, and/or a mud room. A space may have means of ingress and/or egress for entering and/or exiting the space. Such means may include doors, doorways, windows, etc.

In some embodiments, spatial data associated with a space may include data specifying dimensions of the space and/or dimensions associated with the ingress and/or egress means of the space. For example, spatial data associated with a bedroom may include data specifying dimensions (e.g., length, width, height, etc.) of the bedroom, dimensions of doors and/or windows of the bedroom, etc. Similarly, spatial data associated with a patio may include data specifying dimensions (e.g., length, width, diameter for a circular patio, etc.) of the patio. In some embodiments, the spatial data associated with a space may include data specifying the dimensions of the space and/or dimensions associated with the ingress and/or egress means of the space, in any suitable format or units. For example, the dimensions may be specified in particular units (e.g., feet and inches) or as coordinates in a coordinate system.

In some embodiments, spatial data associated with a space may include a three-dimensional (3D) representation of the space. The 3D representation of the space may be a 3D model of the space. The 3D representation of the space may include data collected by performing a 3D scan of the space. A 3D scan of the space may be performed at client computing device 104a, 104b, . . . , 104n. In some embodiments, the 3D scan of the space may be obtained via an augmented reality (AR) software program executing on client computing device 104a, 104b, . . . , 104n. For example, an App associated with the technology platform may be installed on client computing device 104a, 104b, . . . , 104n and may interact with the AR software program (e.g., ARKit for the iOS platform, ARCore for the Android platform, etc.) to generate an AR interface that presents a view of the space. A user may move client computing device 104a, 104b, . . . , 104n to capture the 3D scan of the space via the AR interface. The 3D scan of the space may be captured by scanning multiple surfaces in the space, as described in U.S. Published Patent Application US2020/0320792 entitled “Systems and Methods for Scene-Independent Augmented Reality Interfaces,” the entire contents of which are incorporated by reference herein.

For example, spatial data associated with an indoor space may include a 3D representation of an indoor room (e.g., kitchen), where the 3D representation is generated using data collected by performing a 3D scan of the indoor room. Similarly, spatial data associated with an outdoor space may include a 3D representation of a porch, where the 3D representation is generated using data collected by performing a 3D scan of the porch.

In one embodiment, imagery associated with a space may include one or more images of the space captured using one or more image capture devices. The one or more image capture devices may include one or more optical scanners (e.g., cameras) associated with a client computing device 104a, 104b, . . . , 104n. The one or more image capture devices may be integrated with the client computing device (e.g., as one or more built-in cameras) or alternatively, the one or more image capture devices may be provided separately from the client computing device and images captured by the one or more image capture devices may be transferred to the client computing device, for instance, via wired and/or wireless (e.g., Bluetooth) communication. An image of a space may include only the space (e.g., a picture of the kitchen and no other room) or multiple spaces (e.g., a picture including both a kitchen and a dining room or any other space adjoining the kitchen).

In another embodiment, imagery associated with a space may include one or more synthetic images of the space. One or more synthetic images of a space may be generated in accordance with spatial data associated with the space. In yet another embodiment, imagery associated with a space may include one or more videos of the space.

In some embodiments, imagery associated with a space may include one or more “smart photos” that include both an image of a space and associated metadata indicating, for example, how to create an AR interface using the image. Example of smart photos are described in U.S. Published Patent Application US2020/0320792 entitled “Systems and Methods for Scene-Independent Augmented Reality Interfaces,” the entire contents of which are incorporated by reference herein.

In some embodiments, information about objects within a space may be obtained at server computing device 102. Objects may include furnishings for or in the space, such as, furniture, wall coverings, window treatments, floor coverings, fixtures, and fittings, and/or other decorative accessories. Objects may include appliances in the space (e.g., kitchen appliances (e.g., stove, oven, refrigerator, etc.), laundry appliances (e.g., washer, dryer, etc.), and/or other appliances). Wall coverings may include wall tiles, wallpaper, wall art, wall paint, etc. Window treatments may include curtains, shades, curtain hardware (e.g., curtain rods), and/or other treatments. Floor coverings may include flooring tiles, carpets, hardwood flooring, rugs, etc. Fixtures and fittings may include items that are integrated with or attached to the property (e.g., light fixtures, built-in furniture, existing/installed cabinetry (e.g., bath or kitchen cabinetry), sink, toilet, fireplace, etc.) and items that are not attached to the property (e.g., free-standing appliances (a microwave or air fryer), rugs, etc.).

In some embodiments, the information about the objects may include information specifying positions of the objects in the space. The information about the objects may include information specifying the position and/or dimensions of objects within the space. Information specifying positions and/or dimensions of objects may include data specifying, directly or indirectly, the positions and/or dimensions of the objects. For example, the positions of the objects may be directly specified as coordinates in a coordinate system.

In some embodiments, the information about the objects may include metadata associated with each object, such as, information identifying the object (e.g., product identifier or number, type of object, such as, couch or table, etc.), information identifying the characteristics (e.g., dimensions, materials, color, style, etc.) of the object, information containing feedback about the object from different users (e.g., comments from friends or designers with respect to the object), information indicating a price (e.g., purchase price, resale price, etc.) of the object, information indicating a source (manufacturer information, retailer from where object was purchased, etc.) for the object, information indicating one or more specifications (e.g., manuals, technical specifications, warranties, etc.) for the object, and/or other information.

In some implementations, information about the objects may be obtained by performing a 3D scan of the objects in the space. The information about the objects may be obtained as part of performing a 3D scan of the space. In some implementations, the spatial data associated with the space may include data obtained by performing the 3D scan of the objects in the space. In some embodiments, information about the objects may be obtained by analyzing (e.g., using various image processing techniques) imagery associated with the spaces that the objects are in.

In some embodiments, server computing device 102 may generate a digital representation of a space based on spatial data associated with the space, imagery of the space, and/or information about objects in the space. Server computing device 102 may obtain spatial data, imagery, and/or object information for multiple spaces in a property and generate multiple digital representations for the multiple spaces. Server computing device 102 may generate a digital representation of a property 106a, 106b, 106c, . . . , 106n based on the multiple digital representations of the multiple spaces in the property.

In some embodiments, a digital representation of a property 106a, 106b, 106c, . . . , 106n may include a 3D model of at least a part of the property (e.g., one or multiple areas of a property including indoor and/or outdoor spaces of the property). For example, the digital representation of a property 106a, 106b, 106c, . . . , 106n may include one or more 3D models of one or more indoor spaces or rooms. As another example, the digital representation of a property 106a, 106b, 106c, . . . , 106n may include one or more 3D models of one or more outdoor spaces. In some embodiments, a digital representation of a property 106a, 106b, 106c, . . . , 106n may include information specifying the dimensions of rooms, doors, and/or windows of a property. In some embodiments, a digital representation of a property 106a, 106b, 106c, . . . , 106n may include information specifying the position and/or dimension of objects within the property (e.g., furniture, appliances, fixtures, etc.). In some embodiments, a digital representation of a property 106a, 106b, 106c, . . . , 106n may include 3D models of objects within the property.

In some embodiments, a digital representation of the property 106a, 106b, 106c, 106n may include metadata describing various aspects of the property, including but not limited to: (1) metadata indicating how the data part of the digital representation (e.g., 2D and/or 3D model(s)) was obtained (e.g., who captured the data, when, using what devices, etc.), types of data obtained (e.g., dimensions of spaces within the property), where and manner in which the data is stored, who owns the data and/or whether it is publicly or privately accessible, and what use cases drive the most value (e.g., shopping, services, etc.).

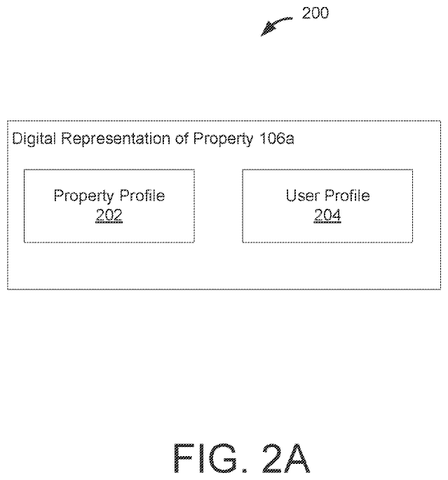

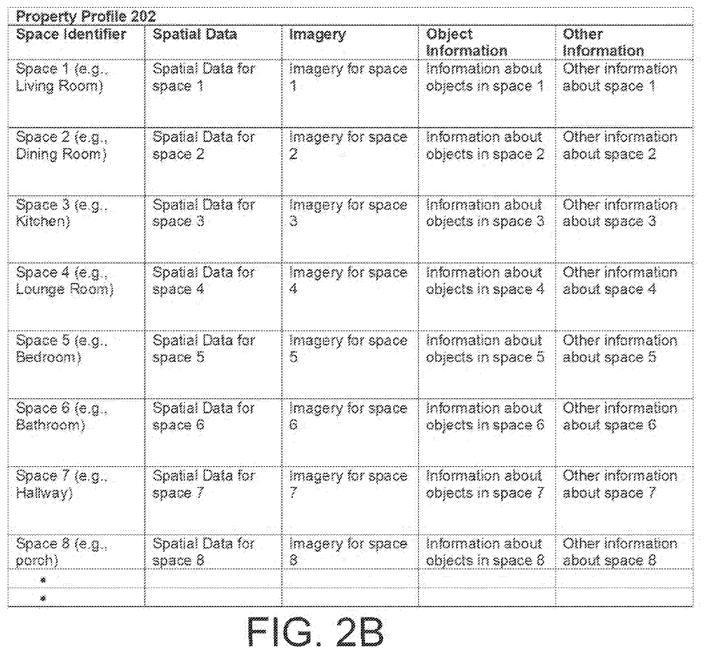

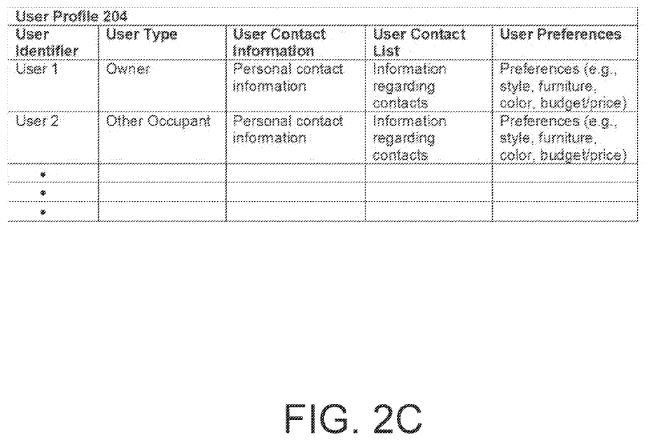

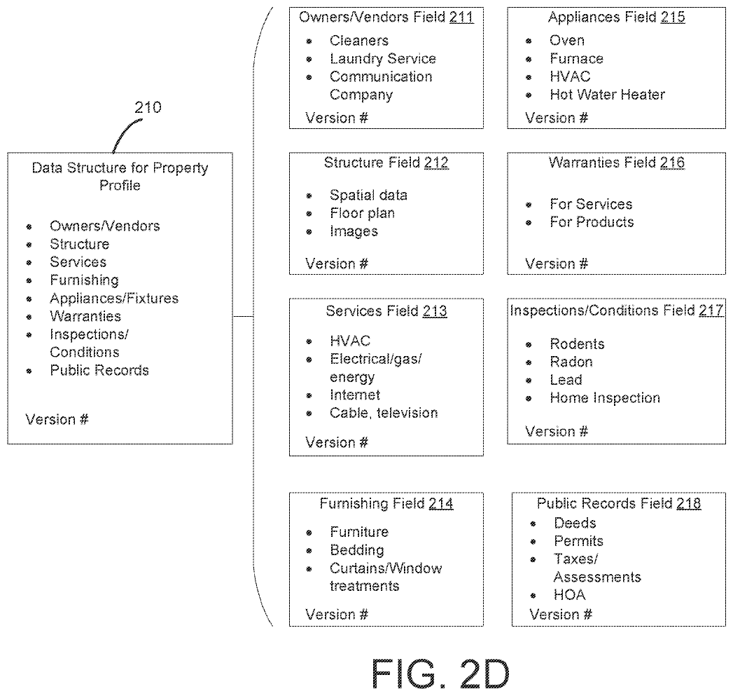

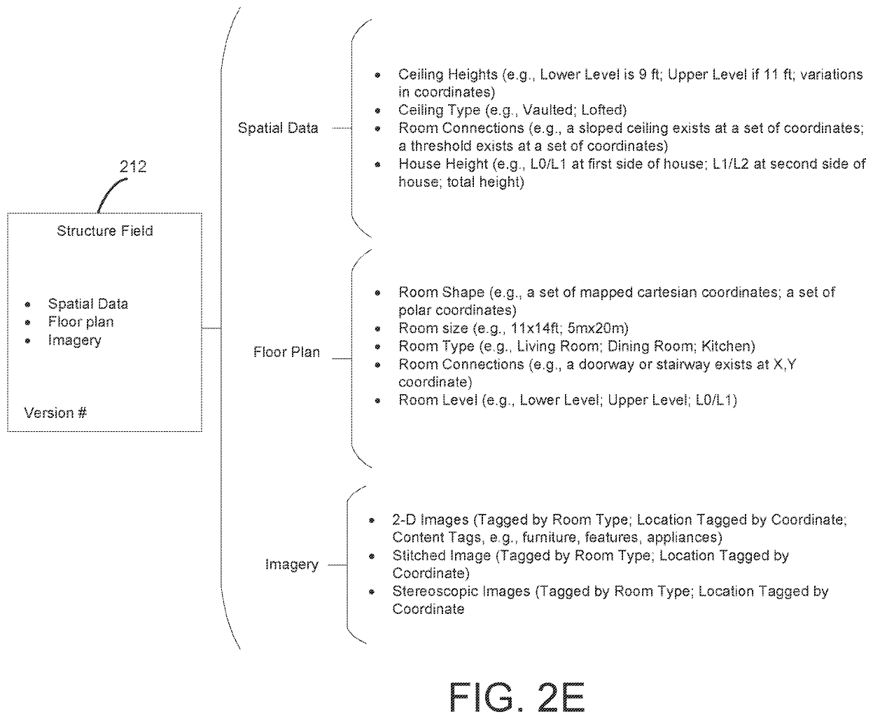

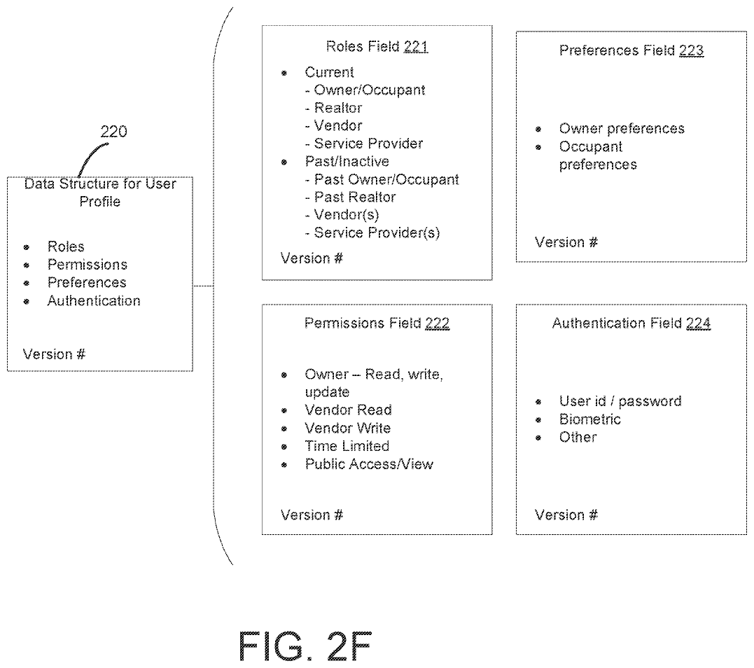

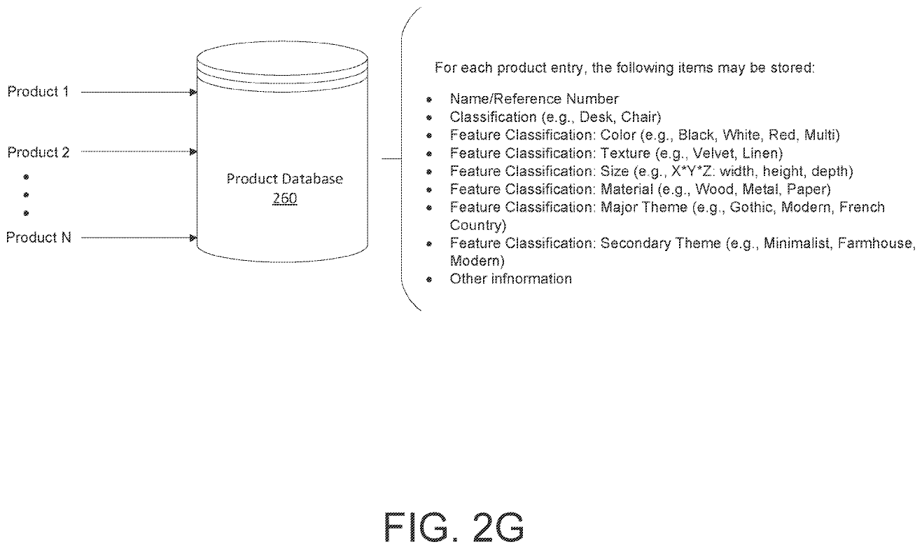

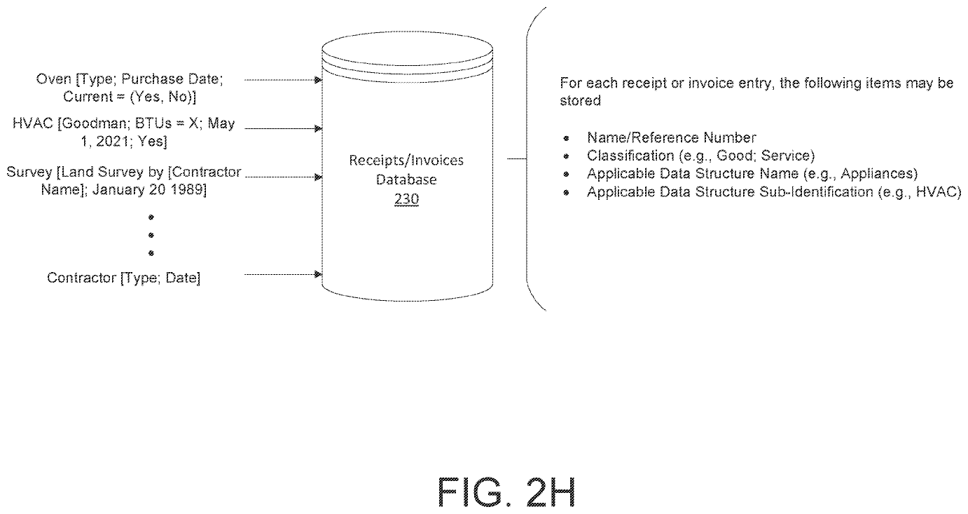

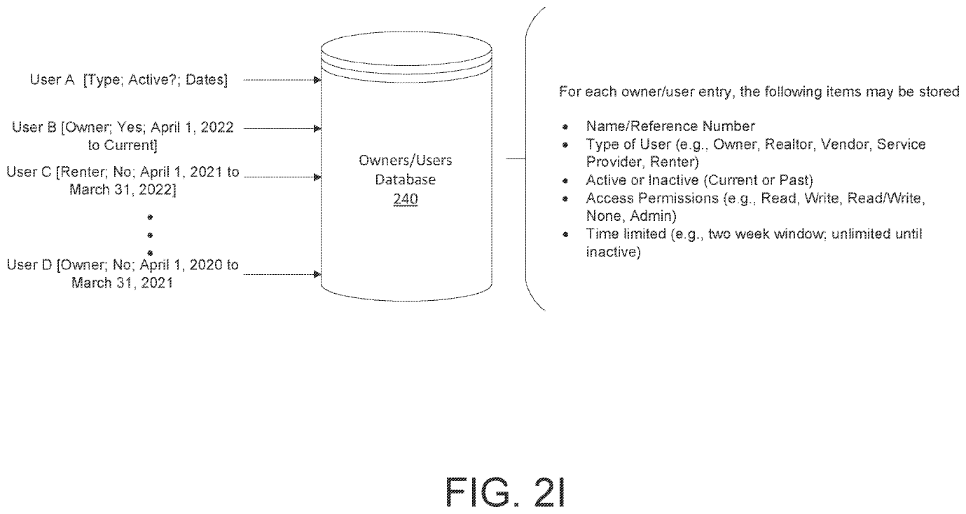

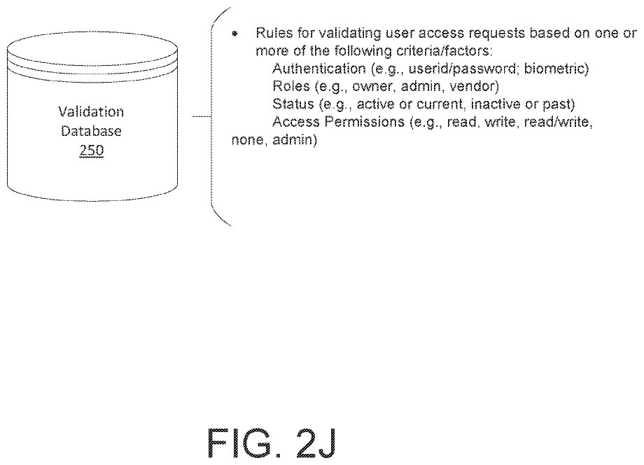

According to some aspects, as shown in FIG. 2A, a digital representation of a property, such as digital representation 106a may include a property profile 202 and a user profile 204. Property profile 202 may include information associated with the address of the property, for example, property profile 202 may include multiple digital representations of multiple respective indoor and/or outdoor spaces of the property. User profile 204 may include metadata associated with an owner and/or an occupant of the property.

FIG. 2B illustrates example contents of property profile 202, according to some embodiments of the technology described herein. Property profile 202 may include information about multiple indoor and/or outdoor spaces of the property. For example, FIG. 2B shows property profile 202 including information about multiple indoor and/or outdoor spaces of a home. Property profile 202 may include spatial data associated with respective indoor and/or outdoor spaces (e.g., living room, dining room, kitchen, lounge room, bedroom, bathroom, hallway, porch, etc.). Property profile 202 may include imagery associated with the respective indoor and/or outdoor spaces. Property profile 202 may include information about objects (e.g., furnishings, furniture, appliances, fixtures, etc.) in the respective indoor and/or outdoor spaces. Property profile 202 may include other information about the respective indoor and/or outdoor spaces, such as, information about means of ingress and/or egress for entering and/or exiting the space (e.g., dimensions of doors, doorways, windows, etc.), relative location of the spaces in or around the property, information about services or service providers utilized for the spaces (e.g., designing services, renovation services, landscaping services, etc.), information about systems installed in the spaces (e.g., sound systems, lighting systems, etc.), and/or other information.

In some embodiments, property profile 202 may include additional information associated with the address of the property. Such information may include information that is publicly available, such as, information about the city or town where the property is located, information indicating when structures were built on the property, tax history associated with the property, permits and/or official records for the property, ownership history for the property, sales/price history for the property and/or current estimates. The information may also include information that may not be publicly available, such as, information about liens on the property, information about historic utility usage for the property, information about fuel/energy usage for the property, an energy assessment for the property, information about maintenance history for the property (e.g., history about when new roof or siding was installed or particular renovations for particular spaces were performed), information about solar energy generation capability for the property, information about consumables needed by the property (e.g., air/water filters, salt for softener, wax for floors, etc.), information about systems installed in the property (security systems, lighting systems, HVAC systems), landscaping information (e.g., trees, shrubs, grass, pool, etc.), insurance information (e.g., history, claims, quotes, etc.), property owner's association information if applicable (e.g., emergency contacts, bylaws, fees, etc.), information about cameras installed in the property (e.g., video feeds, location of camera, type of camera), information about people who have worked on/in the property (e.g., contractors, designers, landscapers, etc.), a link for accessing the 3D model of the property, and/or other non-public information.

In some embodiments, any changes to the property or objects in the property may be tracked over time and the property profile 202 may be updated to store information about those changes. For example, information about changes to the property, such as, replacement of an old roof with a new one, a bathroom renovation, or a kitchen remodel may be stored in the property profile 202. Information about changes to objects in the property, such as, addition of new objects, replacement of old objects, a current status of the objects (e.g., whether maintenance or replacement is due, etc.), when did the object last break, and/or other information may be stored in the property profile 202. Updates to the property profile 202 may be made as and when the changes take place, periodically, and/or at any pre-defined time period.

FIG. 2C illustrates example contents of user profile 204, according to some embodiments of the technology described herein. User profile 204 may include metadata associated with the owner of the property, such as, personal contact information of the owner, information about contacts of the owner (e.g., owner's friends, family, etc.) and their contact information, information about individuals or enterprises that the owner has collaborated with for services in and around the property (e.g., information about designers, contractors, other service providers, etc.), and/or owner's preferences, such as, style preferences, furniture preferences, color preferences, budget/price preferences, and/or other preferences.

In some embodiments, user profile 204 may include metadata associated with other occupants of the property (e.g., parents, children, employees, etc.), such as, personal contact information of an occupant, information about contacts of the occupant and their contact information, and/or occupant's preferences, such as, style preferences, furniture preferences, color preferences, budget/price preferences, and/or other preferences.

In some embodiments, owner's and/or occupant's preferences may be determined by analyzing the owner's and/or occupant's current and past purchase behavior (e.g., styles of products purchased by the owner and/or occupant in the past).

In some embodiments, user profile 204 may include information associated with the owner and/or occupant of the property that is obtained by analyzing the spatial data, imagery and/or information about objects associated with one or more spaces in the property. For example, user profile 204 may store information regarding a number of objects (e.g., furniture, appliances, roofing, siding) owned by or purchased by the owner and/or occupant of the property. For each object, the user profile 204 may include information about the object, such as, style information, maintenance information, warranty information, source information (e.g., retailer from where the object was purchased, whether the object was part of or included in the home when the property was bought, etc.) and/or other information. In some embodiments, maintenance information for an object may include information indicating a stage in the object's lifecycle, such as, how old the object is (e.g., new, 3 years old, 10 years old, etc.) and/or current maintenance status for the object (e.g., good, fair, replacement due, maintenance service due, repair needed, etc.).

In some embodiments, user profile 204 may store authentication information associated with the owner and/or occupant. The authentication information may include a username/user id and password associated with the owner and/or occupant. The authentication information may be used to determine whether the owner and/or occupant is authorized to access the digital representation of the property, for example, when the owner and/or occupant requests access to the digital representation of the property.

Although the various pieces of information associated with owner and/or occupant of the property are described herein as being stored in the user profile, this is by way of example and not limitation. Indeed, any such information may be stored only in the property profile, only in the user profile, or in both the property profile and the user profile, in some embodiments, as aspects of the technology described herein are not limited in this respect.

Referring back to FIG. 1, the generated digital representation of the property may be stored at the server computing device 102 or in a database 120 coupled to the server computing device 102. As shown in FIG. 1, multiple digital representations of properties 106a, 106b, 106c, . . . , 106n may be generated and stored at server computing device 102. Each digital representation of a property may be associated with a respective address of the property.

In some embodiments, information associated with the address of the property, for example, information included in the property profile, may be stored in database 120 using one or more data structures. An example data structure 210 that may be used to store information associated with the property profile is shown in FIG. 2D. Data structure 210 may include a number of data elements or fields for storing different pieces of information (e.g., spatial data, imagery, object information and/or other additional property information) associated with the property profile. For example, data structure 210 may include, among other fields, owners/vendors field 211, structure field 212, services field 213, furnishing field 214, appliances field 215, warranties field 216, inspections/conditions field 217, and public records field 218.

Owners/vendors field 211 may store information about owner(s) of the property and/or vendor(s) or service provider(s) who have worked on/in or otherwise serviced the property (e.g., contractors, designers, landscapers, cleaners, laundry service providers, communication company technicians, etc.). Structure field 212 may store structural information about the property, such as, spatial data (e.g., 3D geometry, dimensions, etc.), floor plans, and/or imagery of the property including multiple indoor and/or outdoor spaces of the property. Services field 213 may store information about services utilized in the property, such as, heating, ventilation, and air-conditioning (HVAC) services, electrical/gas or other energy services, internet services, cable and television services, and/or other services. Furnishing field 214 may store information about furnishings in the property or various spaces of the property, such as, furniture, wall coverings, window treatments, floor coverings, bedding, fixtures, and fittings, and/or other decorative accessories. Appliances field 215 may store information about appliances in the property or various spaces of the property, such as, stove, oven, refrigerator, furnace, HVAC system, hot water heater, washer, dryer and/or other appliances. Warranties field 216 may store information about warranties for existing services or products in the property.

Inspections/conditions field 217 may store information about previous, current, and/or upcoming inspections or conditions of the property such as, information about rodent activity, radon levels, lead levels, home inspection reports, pest control reports, and/or other information. Public records field 218 may store information about the property that is publicly available, such as, information about the city or town where the property is located, information indicating when structures were built on the property, tax history associated with the property, permits and/or official records for the property, ownership history for the property, sales/price history for the property, deeds, home owner association (HOA) fees, and/or current estimates.

FIG. 2E depicts examples of information that may be stored in structure field 212 of data structure 210. Structure field 212 may store spatial data (e.g., 3D geometry, dimensions data) about the property or spaces of the property. Spatial data may include information about dimensions of a space and/or dimensions associated with the ingress and/or egress means of the space. For example, spatial data may include data specifying dimensions (e.g., length, width, height, etc.) of the property or spaces of the property, such as, ceiling heights for various spaces in the property, heights of various sides of the property, total height of the property, and dimensions of doors and/or windows of various spaces. Spatial data may include information associated with other structure elements of the space, such as, type of structural elements (e.g., ceiling type), location of structural elements (e.g., location of sloped ceiling), and/or other structural information. In some embodiments, location may be specified as coordinates in a coordinate system.

Structure field 212 may store floor plan data about the property or spaces of the property. Floor plan data may include information about shape, size, type, location of the spaces, and/or location of connecting spaces in the property. For example, floor plan data associated with a space may include information about the shape of the space (e.g., a set of cartesian or polar coordinates indicating the shape), the size of the space, the type of the space (e.g., bedroom, living room, kitchen, etc.), the level at which the space is located in the property (e.g., lower level, upper level, basement, etc.), and/or location of other spaces connecting the space (e.g., location of a doorway connecting the living room to the kitchen), and/or other floor plan data.

Structure field 212 may store imagery associated with the property or spaces of the property. Imagery may include one or more images of the property or spaces of the property captured using one or more image capture devices. Imagery may include synthetic images, two-dimensional images, stitched images obtained by combining two or more images, stereoscopic images and/or other types of images of the property or spaces of the property. In some embodiments, each image of a space may be tagged or otherwise labeled based on one or more characteristics of the space. For example, an image may be tagged based on the space type (e.g., living room, bedroom, etc.), location of the space (e.g., coordinates of the space), contents of the space (e.g., furniture, appliances, features, etc.), style of the space or contents of the space (e.g., modern, contemporary, rustic, etc.), and/or other characteristics.

In some embodiments, information associated with an owner, occupant, or other user of the property, for example, information included in the user profile, may be stored in database 120 using one or more data structures. An example data structure 220 that may be used to store information associated with the user profile is shown in FIG. 2F. Data structure 220 may include a number of data elements or fields for storing different pieces of information (e.g., roles, permissions, preferences and/or other additional user information) associated with the user profile. For example, data structure 220 may include, among other fields, roles field 221, permissions field 222, preferences field 223, and authentication field 224.

Roles field 221 may store information indicating roles or types of various users of the property, such as, owners, realtors, vendors, service providers, renters, and/or other roles. Roles field 221 may store information indicating a status associated with the role, for example, current or active owner versus a past or inactive owner. Similar status information may be stored for various users of the property. Roles field 221 may stores timeline information associated with various users of the property, for example, a past owner's timeline may indicate that he owned the property from Apr. 1, 2020-Mar. 31, 2021, a renter's timeline may indicate that he rented the property from Apr. 1, 2021-Mar. 31, 2022, and a current owner's timeline may indicate that he has owned the property since Apr. 1, 2022. Roles field 221 may store metadata associated with the users with the various roles, such as, personal contact information of the user, information about contacts of the user and their contact information, and/or other metadata.

Permissions field 222 may store access permissions for various users of the property and/or authentication information associated with the users. The access permissions may depend on the roles or types of the users. Access permissions associated with a user may indicate whether the user is permitted to access a digital representation of the property/spaces of the property and the type of access (read, write, update, admin, no access, etc.) or level of access (full access or limited access) permitted. For example, a current owner of the property may be permitted to read, write, and/or update the digital representation of the property whereas a past owner may not be permitted to access the digital representation of the property. As another example, a first vendor, such as a landscaper, may be permitted to read the digital representation of the property whereas a second vendor, such as a designer assisting with a remodeling project for the property, may be permitted to read and write the digital representation of the property. As yet another example, one or more users of the property may be permitted to access the digital representation of the property for a limited period of time (e.g., for the duration of remodeling project). As another example, one or more users of the property may be permitted to access a subset of information associated with the property. In this scenario, the user(s) may be permitted to access or view only some of the information stored in the property profile, such as, publicly accessible information about the property and/or only some of the data associated with the digital representation of the property/spaces of the property (for example, only images and floor plans of the kitchen that is being remodeled). In some embodiments, different users may be permitted to access data associated with different spaces of the property. For example, a renter or realtor of the property may be permitted to access information associated with multiple spaces (e.g., kitchen, bedrooms, living room, patio, dining room, basement, etc.) of the property whereas the designer assisting with the remodeling project may be permitted to access information associated with only the kitchen and spaces connecting the kitchen (e.g., pantry, doorway leading to the dining room, etc.).

Preferences field 223 may store information about the users' (e.g., owner's or occupant's) preferences, such as, style preferences, furniture preferences, color preferences, budget/price preferences, and/or other preferences. Authentication field 224 may store authentication information associated with the various users of the property, such as, user id and password information, biometric information, and/or other forms of authentication information.

In some embodiments, updates to the user profile may be made as and when changes take place, periodically and/or at any pre-defined time period. For example, information in the roles, permissions, and/or authentication fields may be updated to reflect changes in information associated with the user, such as changes in authentication information (e.g., changing a user id or password), changes in roles (e.g., changing a current or active vendor to past or inactive vendor when a project is completed), and/or changes to permissions (e.g., changing an access type or level of access for a user, such as, changing a read and write permission for a designer currently working on a project to a read permission when the project is completed).

It will be appreciated that FIGS. 2D-2F illustrate example data structures for storing information associated with a property profile and/or user profile of the property. Other types or formats of data structures may be used to store this information without departing from the scope of the disclosure. For example, information associated with a property profile and/or user profile may be stored in a data file, an array, an associative array, a JSON (JavaScript Object Notation) representation, and/or using other data structures and formats.

In some embodiments, additional information associated with the property or spaces of the property may be stored in database 120. As an example, receipts or invoice information associated with objects purchased or services requested by the user may be stored in database 120. The receipts or invoice information stored in database 120 may include, among other things, a name or reference number, purchase or service date, type of object purchased or type of service requested, details regarding the object purchased or service requested, and/or other information. For instance, for an HVAC purchase, the brand name of the HVAC, the BTU rating for the HVAC, and/or other information may be stored. For a property service, the type of service (e.g., land survey), the service date, the name of the contractor who performed the service, and/or other information may be stored.

In some embodiments, system 100 may include product database 260 that stores information about products listed in or available via an online product catalog as shown in FIG. 2G. For each product, the product database 115 may include information about the product, such as, a name or reference number, one or more images of the product, one or more 3D models of the product, product classification (e.g., desk, chair, couch, etc.), and/or feature classification, such as, color (e.g., black, while, red, multi-colored, etc.), texture (velvet, linen, etc.), size (e.g., width, height and depth information), material (e.g., wood, metal, paper, etc.), major theme or style (e.g., Gothic, Modern, French Country, etc.) and secondary theme or style (e.g., Minimalist, Farmhouse, Modern, etc.).

Multiple digital representations of properties 106a, 106b, 106c, . . . , 106n may be generated and stored in database 120. It will be appreciated that while FIGS. 2A-2F describe types of data (e.g., in property profile and/or user profile) that can be stored or maintained for a single property, such data may be stored or maintained for any number of properties managed by system 100. For instance, a property profile and/or user profile may be maintained for each property managed by system 100.

While the embodiments above describe data associated with multiple digital representations of properties being stored in database 120 and data associated with products in an online product catalog being stored in database 260, it will be appreciated that this data may additionally or alternatively be stored in one or more other databases 115 as aspects of the technology is not limited in this respect. For example, data about owners or other users of various properties may be stored in a owners/users database 240 as shown in FIG. 2I, receipts or invoice information associated with various properties may be stored in a receipts/invoices database 230 as shown in FIG. 2H, and so on.

In some embodiments, system 100 may include a validation database 250 that stores validation rules for validating user requests to access digital representations of properties for purposes of determining whether access to the digital representations is authorized and/or permitted. The rules may define criteria or factors for validating user requests as shown in FIG. 2J. In response to a user request, one or more rules from the validation database may be utilized by the system 100 to determine whether the user is permitted to access the digital representation. For example, a user may request to update (read/write) a digital representation of a property. The user request may identify the user, the property, and the type of access (e.g., read/write) requested. A digital representation of the property, from among multiple digital representations of multiple properties managed by the system 100, may be identified based on the property identifier in the user request. The property profile 202 and/or user profile 204 associated with the digital representation may be analyzed to identify authentication information, roles information, status information, and/or permissions information associated with the user requesting access. One or more rules that define criteria for read/write access may be utilized to determine whether the user is permitted to read and write to the digital representation. For example, a first rule may indicate that only an authorized active owner, an authorized active vendor, or authorized admin user may be permitted to read/write to the digital representation, a second rule may indicate that an authorized active renter or authorized active realtor may be permitted to read the digital representation, and a third rule may indicate that an unauthorized or inactive user may not be permitted to access (read, write etc.) the digital representation. Based on the authentication information, roles information, permissions information, and/or status information associated with the user requesting access, a determination may be made regarding whether the user is authorized and permitted to access the digital representation of the property.

It will be appreciated that various types of rules may be defined for validating user requests. As one example, rules that include criteria for validation based on request type may be defined, where different rules may be defined for different types of access requested. As another example, rules that include criteria for role-based validation may be defined, where different rules may be defined for each role. As another example, rules that include criteria for property-based validation may be defined, where the validation database 150 may include a set of rules for each property. Other types of validation rules may be defined as aspects of the technology described herein are not limited in this respect.

In some embodiments, one or more digital representations of properties 106a, 106b, 106c, . . . , 106n may be accessed to generate visualizations of the multiple spaces in the properties. Various users of system 100 may access the one or more digital representations of properties 106a, 106b, 106c, . . . , 106n via client computing devices 104a, 104b, . . . , 104n. In some embodiments, a visualization of a space may be a computer-generated visual representation of the space. The visual representation may be a two-dimensional (2D) or three-dimensional (3D) representation. In some embodiments, a visual representation may comprise an image, multiple images, or a video. In some embodiments, the visual representation may be an augmented reality (AR) representation, whereby one or more virtual objects are overlaid onto one or images of a physical scene. Such an AR representation may be displayed using one or more AR-capable devices. In some embodiments, the visualization may be a virtual reality (VR) representation and may be displayed using one or more VR-capable devices.

In some embodiments, accessing the one or more digital representations of properties 106a, 106b, 106c, . . . , 106n may include obtaining the one or more digital representations of properties 106a, 106b, 106c, . . . , 106n from the server computing device 102 in response to a user request via any client computing device 104a, 104b, . . . , 104n. In these embodiments, the one or more digital representations of properties 106a, 106b, 106c, . . . , 106n may be communicated from the server computing device 102 to a client computing device 104a, 104b, . . . , 104n via communication network 110.

In some embodiments, a digital representation of a property, such as, digital representation 106a, may be stored at a client computing device 104a associated with, for example, the owner of the property. In these embodiments, accessing the digital representation may include retrieving the digital representation of the property from memory associated with the client computing device 104a.

According to some embodiments, an interactive user interface (e.g., interfaces 600, 700, 802, 810, 820, 830, 910, 920, 1000, 1100, 1102, 1200, 1210, 1220, 1300, 1310, 1320, 1330, 1400, 1500, 1510, 1520, 1530, 1600, 1700, 1710) may be generated using the one or more digital representations of properties 106a, 106b, 106c, . . . , 106n. The interactive user interface may allow a user to perform one or more actions with respect to the multiple spaces in a property. The one or more actions may include updates to the digital representation of the property, actions related to shopping for products for the property, actions relating to re-arranging objects in the property, actions relating to collaboration with one or more other users (e.g., designers, contractors, contacts, service providers, etc.) or partner enterprises, and/or other actions described herein.

According to some embodiments, the interactive user interface may include an AR interface, a VR interface, and/or any other extended reality (XR) interface that allows a user to interact with the interactive user interface to perform actions with respect to multiple spaces in a property.

### Example Processes

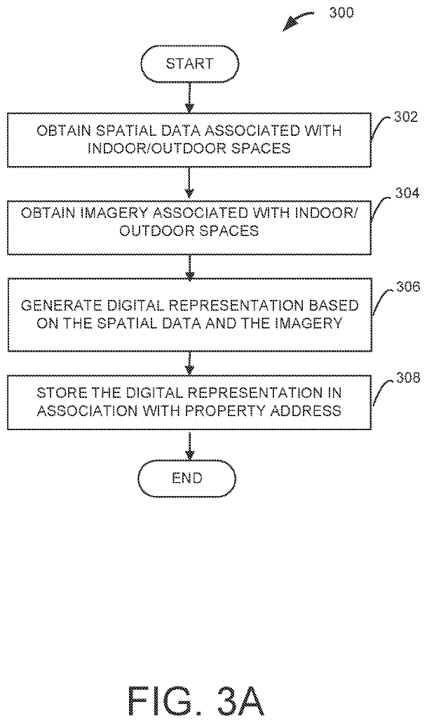

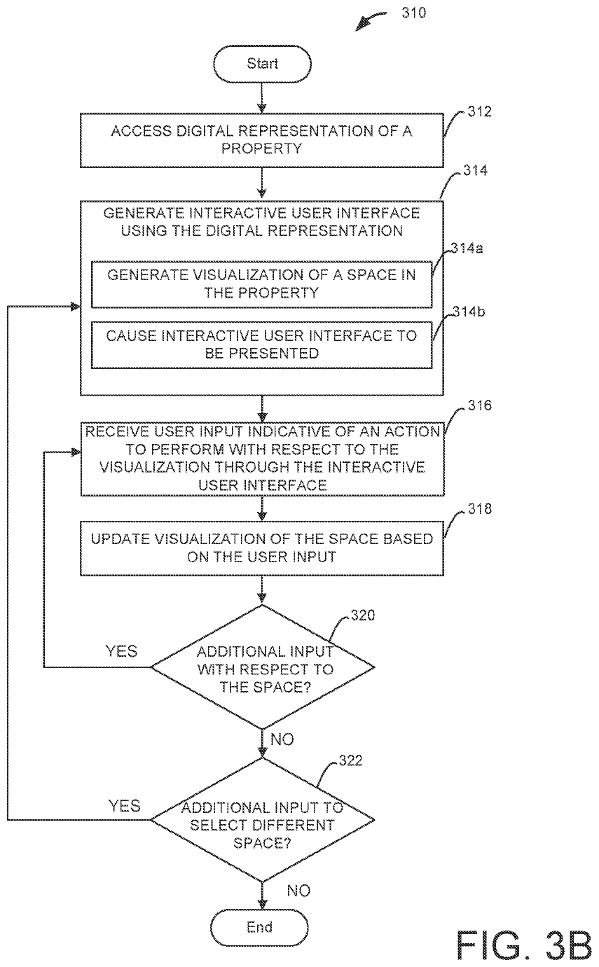

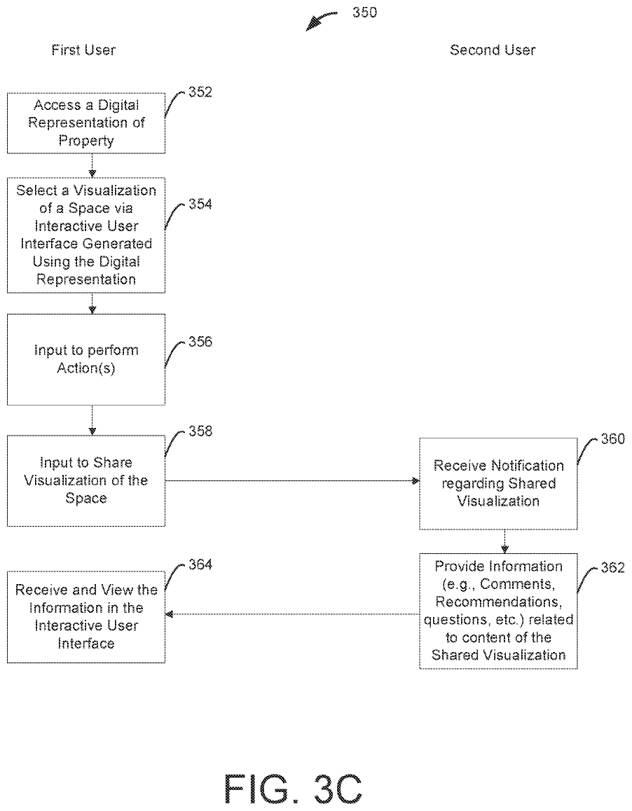

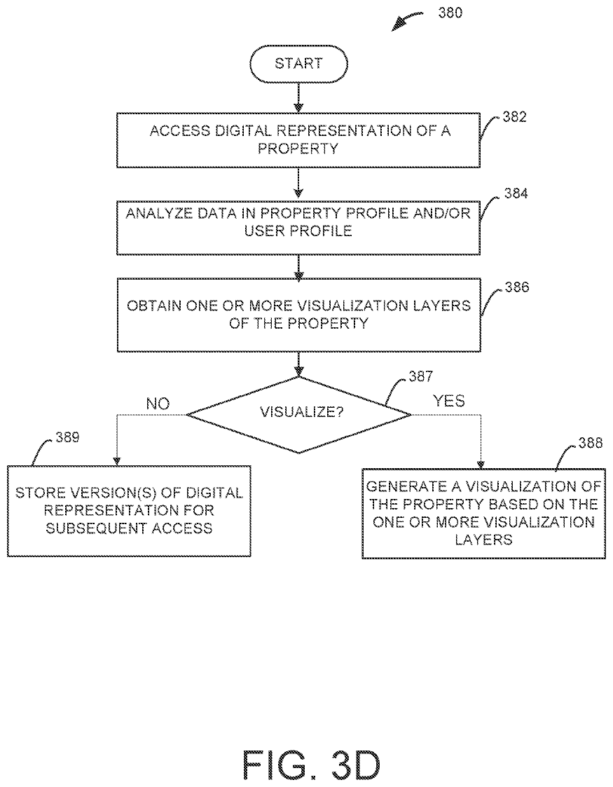

FIG. 3A shows an example process 300 for generating and storing a digital representation of a property. The process 300 may be performed using a computing device such as a server computing device 102 or any client computing device 104a, 104b, . . . , 104n described above with reference to FIG. 1. As shown in FIG. 3A, the process 300 comprises an act 302 of obtaining spatial data associated with multiple indoor and/or outdoor spaces of a property; an act 304 of obtaining imagery associated with the multiple indoor and/or outdoor spaces; an act 306 of generating the digital representation of the property based on the obtained spatial data and imagery; and an act 308 of storing the digital representation of the property in association with an address of the property.

In act 302, spatial data associated with multiple indoor and/or outdoor spaces of a property may be obtained. In some embodiments, spatial data associated with a space may be obtained using client computing device 104a, 104b, . . . , 104n. The spatial data associated with the space may include spatial data specifying dimensions of the space. The spatial data of the space may include data collected by performing a 3D scan of the space and/or 3D scan of one or more objects in the space using the client computing device 104a, 104b, . . . , 104n. The spatial data of the space may include a 3D representation (e.g., 3D model) or a 2D representation (e.g., 2D model) of the space. The spatial data of the space may include information (e.g., position and/or dimensions) about one or more objects in the space, information (e.g., position and/or dimensions) about means of ingress and/or egress for entering and/or exiting the space. The spatial data of the property may include information specifying dimensions and relative location of the multiple indoor and/or outdoor spaces of the property.

In some embodiments, obtaining spatial data of a property at server computing device 102 may include obtaining spatial data associated with multiple indoor and/or outdoor spaces of the property from client computing device 104a, 104b, . . . , 104n. The spatial data of the property may be collected using client computing device 104a, 104b, . . . , 104n and communicated to server computing device 102 via communication network 110.

In act 304, imagery associated with the multiple indoor and/or outdoor spaces of the property may be obtained. In some embodiments, obtaining imagery associated with a space at a client computing device 104a, 104b, . . . , 104n may include capturing one or more images or videos of the space using a camera associated with client computing device 104a, 104b, . . . , 104n. In some embodiments, obtaining imagery associated with a space may include generating, at client computing device 104a, 104b, . . . , 104n, one or more synthetic images in accordance with spatial data associated with the space. In some embodiments, images and/or videos of the space may be analyzed to identify objects in the space. The identified objects may be tagged or otherwise labeled based on one or more characteristics of the object.

In some embodiments, obtaining imagery of a property at server computing device 102 may include obtaining imagery associated with multiple indoor and/or outdoor spaces of the property from client computing device 104a, 104b, . . . , 104n. The imagery of the property may be captured or generated using client computing device 104a, 104b, . . . , 104n and communicated to server computing device 102 via communication network 110. In some implementations, server computing device 102 may generate the one or more synthetic images for one or more spaces of the property in accordance with spatial data associated with the respective spaces obtained from the client computing device 104a, 104b, . . . , 104n.

In some embodiments, spatial data and/or imagery of the property may be collected using a mobile device or AR headset. In these embodiments, an owner and/or occupant of the property may collect this information via the technology platform App installed on their mobile device.

In some embodiments, the spatial data and/or imagery may be collected through a third-party service, by mining public data, and/or through various partner individuals/enterprises (e.g., real-estate agents; real estate investment trusts (REIT); building developers; property managers of apartment buildings, condominiums, or rental properties; property inspectors; insurance agencies, etc.).

In some embodiments, the spatial data may be determined from blueprints or plans of the property. In some embodiments, the spatial data and/or imagery may be collected during design projects, construction projects, re-design projects, renovation projects and/or other projects. The spatial data and/or imagery may be collected by incentivizing owners to collect and share data about their properties. In some embodiments, system 100 may generate and provide incentives to current property owners to share non-public information about their property.

Spatial data associated with a property may be collected in numerous ways including, but not limited to, collecting spatial data when a user buys furnishing for the property/space of the property, collecting spatial data about existing appliances and new appliances, (for example, when a user buys the new appliances), collecting spatial data when buying or selling the property, and collecting spatial data during property inspections.

In some embodiments, additional information about the property may be collected and used to generate a digital representation of the property. The additional information may include information collected as part of subscription services (e.g., information about repairs performed at the property or consumables needed by the property (renovations, repairs, cleaning, assembly etc.)). The additional information may include information about services/service providers for the property (subscription, installation, assembly, maintenance, light renovation, tech support, medium renovation, cleaning, large construction, providers typically servicing the property, etc.). Additional information about objects purchased may be obtained from receipts associated the purchases. This information may be collected at the point of sale (POS) as an opt-in process or provided by the user at some point after the purchase. For example, system 100 may allow a user to upload receipts associated with purchases made and may store receipts information in receipts/invoices database 230. As part of storing the receipts information, system 100 may, based on user input, associate the purchased object with a space of the property. For example, the user may indicate that purchased object is a couch that belongs in the living room. Based on the user input, information associated with the couch may be added to the digital representation of the property, for example, by updating the information about objects associated with “Space 1” in the property profile 202.

In some embodiments, system 100 may prompt a user (e.g., owner) to share information about the property during or after a shopping session. For example, the user may visit an online ecommerce website associated with a retailer to buy furniture for the property or space in the property. During the shopping session, the user might consider creating a model of the space. The user may click a link that says: “My Space.” In response, the user may be asked “What's the address of your space?” In some embodiments, the retailer system may already have a digital representation of a property associated with the address. In other embodiments where the retailer system does not already have a digital representation of the property, the user may be provided a notification saying: “Sorry we don't currently have any information about that address. You can be the one who gets credit for creating it! Start by giving us the name of the room or space you want to model: [ ].” In some embodiments, there may be opt outs and ways for people to keep their spaces private. If the user chooses to share information about the address/property/space, the user may be guided through various prompts to provide information about various spaces/rooms (e.g., dimensions, and/or other features) in the property. In some embodiments, authentication steps may be performed requiring the user to prove that he/she owns the property before information about the property (e.g., digital representation of the property) is shown to the user. In some embodiments, information about the property may be collected from the user once they move out or sell the property.

In some embodiments, system 100 may prompt the user to share information about the property after purchase of a product for the property (e.g., after purchase of appliances, such as, a washer and dryer set for a home). On a receipt page of the order on the online ecommerce website, the user may be prompted with a popup that says “Congrats on the new Washer and Dryer! Let's work together to maintain information about what is in your property. Want to get started by registering your new appliances? Click here!” If the user chooses to provide this information, the user may be guided through various prompts to provide appliance related information. In some embodiments, the user may first be asked if the address they are shipping to is where the appliance will be used. That address may be used to determine whether information about the property or information about other appliances at the property location already exists. In response to a determination that the information exists, the user is made aware of and presented this information after some authentication steps. In response to a determination that the information does not exist, the user may be prompted to start creating a digital representation of the property which would benefit him/her and future owners. The foregoing messages and/or prompts are non-limiting examples.

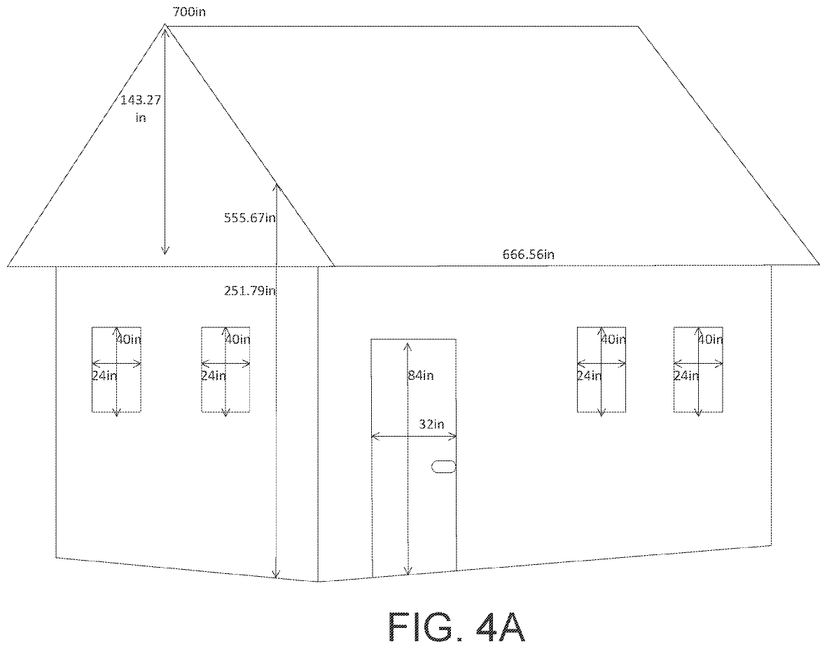

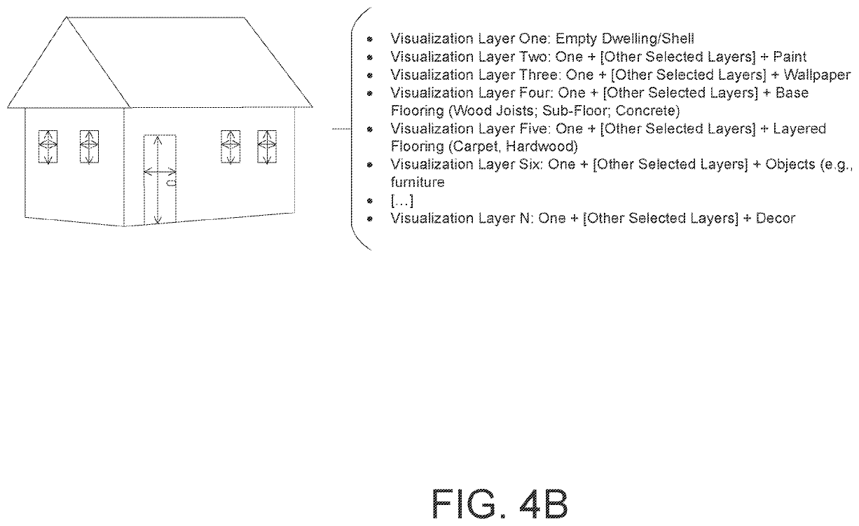

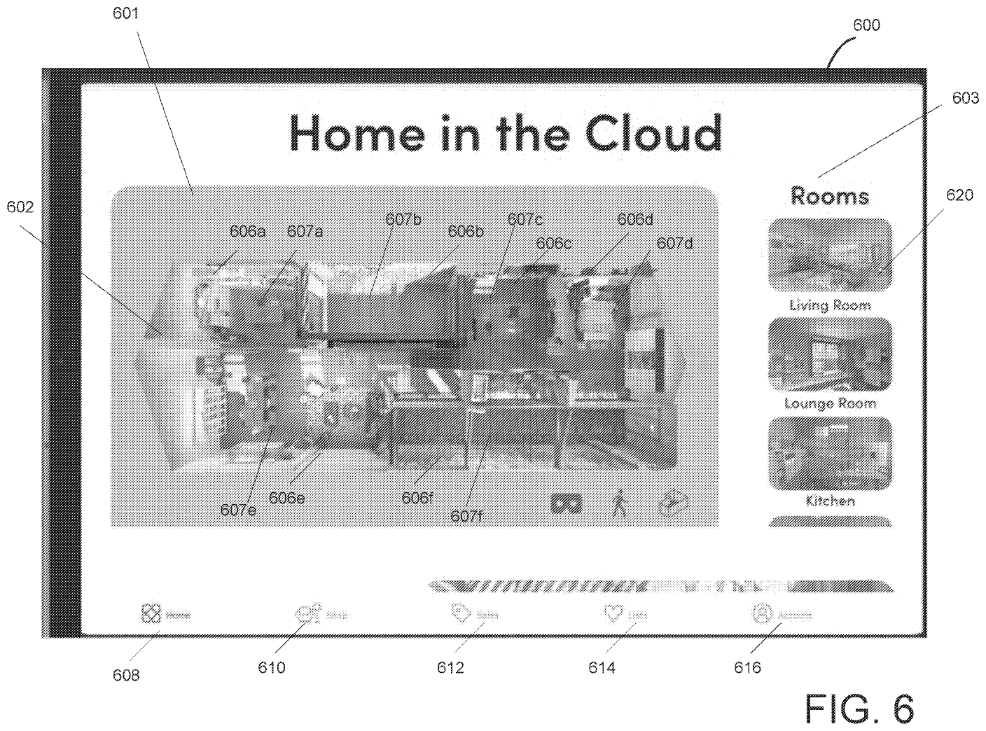

In act 306, a digital representation of the property 106a, 106b, 106c, . . . , 106n may be generated based on the obtained spatial data associated with the property, imagery associated with the property, information about objects in the property and/or other information about the property. The digital representation of the property 106a, 106b, 106c, . . . , 106n may include a 3D model of the property as shown in FIG. 4A, for example. The digital representation of the property 106a, 106b, 106c, . . . , 106n may include a combination of multiple digital representations of the multiple indoor and/or outdoor spaces (e.g., 607a, 607b, 607c, 607d, 607e, 607f, etc.) of the property as shown in FIG. 6, for example. In some embodiments, a property profile (e.g., property profile 202 shown in FIG. 2B) and a user profile (e.g., user profile shown in FIG. 2C) may be included for each digital representation of a property 106a, 106b, 106c, . . . , 106n.

In some embodiments, the digital representation of the property 106a, 106b, 106c, . . . , 106n may include one or more visualization layers that enable generation of visualizations of the property or spaces in the property. The one or more visualization layers may be generated based on the obtained spatial data associated with the property, imagery associated with the property, information about objects in the property and/or other information about the property. Each visualization layer may include information that enables visualization of a different aspect of the property or spaces in the property. For example, a first or base visualization layer may include information for generating a base visualization of the property or spaces in the property, such as an empty 3D model of the property or shell of the property. Additional visualization layers may include information for generating visualizations of different aspects, components, or objects of the property overlaid onto the base visualization layer. As one example, an additional visualization layer may include information for generating a visualization that enables painted surfaces of the property or spaces of the property to be visualized. As another example, an additional visualization layer may include information for generating a visualization that enables surfaces of the property or spaces of the property with wallpaper to be visualized. As yet another example, an additional visualization layer may include information for generating a visualization that enables base flooring (e.g., wood joists, sub-floor, concrete, etc.) of the property or spaces of the property to be visualized. As another example, an additional visualization layer may include information for generating a visualization that enables layered flooring (e.g., carpet, hardwood, etc.) of the property or spaces of the property to be visualized. As another example, an additional visualization layer may include information for generating a visualization that enables objects, such as furniture, in the property or spaces of the property to be visualized. As yet another example, an additional visualization layer may include information for generating a visualization that enables a décor of the property or spaces of the property to be visualized.

FIG. 4B illustrates examples of visualization layers that enable generation of visualizations of the property or spaces of the property. Other visualization layers that enable visualization of other aspects, components, or objects of the property/spaces in the property may be used to generate visualizations (along with or independently of the base visualization layer) as aspects of the technology are not limited in this respect. In addition, two or more visualization layers may be used to generate visualizations that enable multiple aspects, components, or objects of the property/spaces in the property to be visualized simultaneously. To generate a particular visualization of the property, any one of the visualization layers mentioned above may be used, a combination of two or more of the visualization layers mentioned above may be used and/or a combination of one or more of the visualization layers mentioned above and one or more other visualization layers that enable visualization of other aspects, components, or objects of the property/spaces in the property may be used.

In act 308, a digital representation of the property 106a, 106b, 106c, . . . , 106n may be stored in association with the address of the property. In some embodiments, a digital representation of a property may be stored at server computing device 102. Server computing device 102 may store a plurality of digital representations associated with a plurality of properties, either generated at the server computing device 102 or obtained from various client computing devices 104a, 104b, . . . , 104n.

In some embodiments, a digital representation of a property may be stored at a client computing device 104a, 104b, . . . , 104n. For example, a client computing device, such as device 104a, may store a digital representation of a property owned by a user of the device 104a.

In some embodiments, a client computing device, such as device 104a, may be utilized by a user (e.g., owner of a property) to obtain spatial data and imagery associated with the property. A digital representation of the property may be generated at the client computing device 104a based on the obtained spatial data and imagery. The generated digital representation of the property may be stored at the client computing device 104a and/or communicated to server computing device 102. In other embodiments, the digital representation of the property may be generated at the server computing device 102 based on the spatial data and imagery associated with the property received from the client computing device 104a.

In some embodiments, an owner created and verified digital representation may be considered a “true” or original version of a digital representation. An owner may be permitted to update the “true” version of the digital representation, for example, when an authenticated purchase is made. Updating the “true” version may include replacing the “true” version with an updated version or bookmarking/stamping on a timeline the new “true” version.

In some embodiments, multiple versions of the digital representation may be generated and/or stored. The multiple versions may be generated by branching the “true” version of the digital representation to permit the multiple versions of the digital representation to exist in parallel form. In some embodiments, the multiple versions may include read-only copies of the “true” version, editable copies of the “true” version, and/or other versions. In some embodiments, a version of the digital representation may include all or some of the data associated with the “true” version.

FIG. 3B shows an example process 310 for accessing and using a digital presentation of a property. The process 310 may be performed using a computing device such as a server computing device 102 or any client computing device 104a, 104b, . . . , 104n described above with reference to FIG. 1. As shown in FIG. 3B, the process 310 comprises an act 312 of accessing a digital representation of a property; an act 314 of generating an interactive user interface using the digital representation of the property; an act 316 of receiving user input indicative of an action to perform with respect to a visualization of space in the property through the interactive user interface; an act 318 of updating the visualization of the space based on the user input; and acts 320, 322 of determining whether additional input about the space or a different space is received.

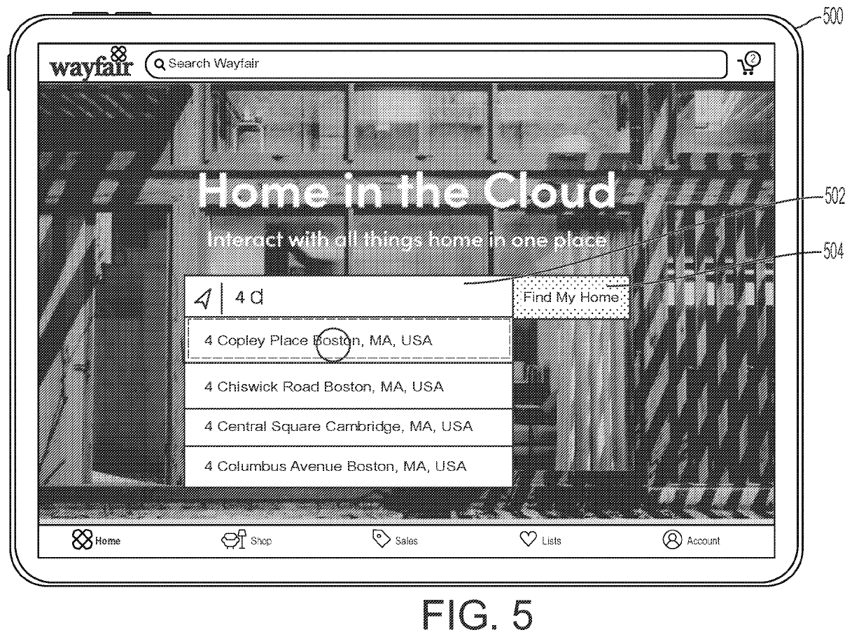

In act 312, a digital representation of a property 106a, 106b, 106c, . . . , 106n may be accessed. The digital representation of the property may be accessed via the technology platform App installed on client computing device 104a, 104b, . . . , 104n. The App may generate a user interface that allows a user to access the digital representation of the property. FIG. 5 illustrates an example screen capture of user interface 500 that allows a user to access a digital representation of a property, such as a home, by providing an address associated with the home. For example, user interface 500 may include an interface element 502 for accepting user input about an address of the home. The digital representation of the home associated with that address may be accessed in response to user selection of interface element 504. In some embodiments, accessing the digital representation of the home may include obtaining the digital representation of the home from server computing device 102. In some embodiments, accessing the digital representation of the home may include retrieving the digital representation of the home from memory associated with client computing device 104a, 104b, . . . , 104n.

In some embodiments, a digital representation of a property 106a, 106b, 106c, . . . , 106n may be accessed via applications, websites, and/or other mapping platforms offered by mapping information providers (such as, Google Maps). For example, the user may search for an address of a property on Google Maps. In addition to the street view and aerial view, a link “Get Details” may be provided on Google Maps. Clicking this link might provide a user with access to a digital representation of a property. For example, the user may be able to view a 3D model of the property or be taken to an overview page of the property. Due to privacy concerns, authentication steps may be performed prior to providing access to the digital representation of the property, but with successful authentication the user may obtain access to information about the property including but not limited to: information indicating when structures were built on the property; tax history for the property; permits and official records for the property, ownership history, sales/price history and current estimates, historic utility usage, fuel and energy usage, energy assessment information, maintenance history information, solar energy generation capability, consumables needed by the property, appliances in the property and their manuals, furniture and other furnishings in the property, security system information, lighting system information, sound system information, HVAC information, landscaping information, insurance information, association information (e.g., home owner's association), video feeds for cameras in the property, contact lists of people who have worked on/in the property, a link into the 3D model of the property and buildings. Although the above example is described with respect to Google Maps, other mapping information providers, housing information providers, real estate and/or content provider companies (e.g., ZILLOW, REDFIN, AIRBNB, AMAZON, FACEBOOK, MICROSOFT, MATTERPORT, etc.) may also support providing access to digital representations of properties.

In some embodiments, user authentication may be performed to determine whether the user is authorized to access the digital representation of the property. In some implementations, user profile 204 associated with the digital representation of the property may include authentication information for one or more users authorized to access the digital representation. For example, in response to a user request (e.g., by selecting interface element 504) to access the digital representation of the home, the user may be prompted to provide authentication information (e.g., a username/user id and password). This authentication information may be compared against the authentication information in the user profile 204. In response to a match, a determination may be made that the user is authorized to access the digital representation of the home. On the other hand, in response to a mismatch, a determination may be made that the user is not authorized to access the digital representation of the home. The interface may allow a user a certain number of attempts to provide the matching authentication information and a determination that the user is not authorized may be made after a certain number of unsuccessful attempts. Other forms of authentication information (e.g., biometric information) may be stored in the user profile and requested from the user during the authentication process, as aspects of the technology described herein are not limited in this respect.

In some embodiments, accessing the digital representation of the property comprises obtaining spatial data, imagery, and/or information about objects associated with one or more spaces of the property. In act 314, an interactive user interface, such as interface 600 of FIG. 6, may be generated using the digital representation of the property. In some embodiments, generating the interactive user interface may include (1) an act 314a of generating one or more visualizations of the one or more spaces of the property using the spatial data and imagery associated with the one or more spaces, and (2) an act 314b of causing the interactive user interface to be presented to the user.

In act 314a, one or more visualizations of the one or more spaces may be generated. The visualizations may be generated using spatial data and imagery associated with each space of the one or more spaces. The visualizations may be presented via the interactive user interface, such as interface 600 of FIG. 6. FIG. 6 shows an interactive user interface 600 being presented to the user that includes visualizations 606a, 606b, 606c, 606d, 606e, 606f of spaces 607a, 607b, 607c, 607d, 607e, 607f in a home. In some embodiments, the visualizations of the spaces may include visualizations of objects in the spaces. The object visualizations may be generated using the information about objects in the respective spaces. For example, visualizations of 3D models of the objects may be generated using the spatial data, imagery, and/or information about the objects obtained from the digital representation of the property. In some implementations, information about objects in a space may be derived from the spatial data and imagery associated with a space. For example, the imagery may be analyzed using various image processing techniques to identify the objects and/or information about the objects in the space.

In implementations where the interactive user interface is generated at server computing device 102, causing the interactive user interface to be presented in act 314b may include generating a web interface at server computing device 102 that allows a user at any client computing device 104a, 104b, . . . , 104n to interact with content of the web interface (including the visualizations) via a client program (e.g., a web browser). In other implementations, causing the interactive user interface to be presented includes providing, by server computing device 102, information about the visualizations to any client computing device 104a, 104b, . . . , 104n, which are then displayed at the client computing device.

In implementations where the interactive user interface is generated at client computing device 104a, 104b, . . . , 104n, causing the interactive user interface to be presented in act 314b may include displaying the one or more visualizations of the one or more spaces at the client computing device.

In some implementations, the interactive user interface may include an AR, VR, or other extended reality (XR) interface. In these embodiments, causing the interactive user interface to be presented to the user may include causing the AR, VR, or XR interface to be presented to the user.

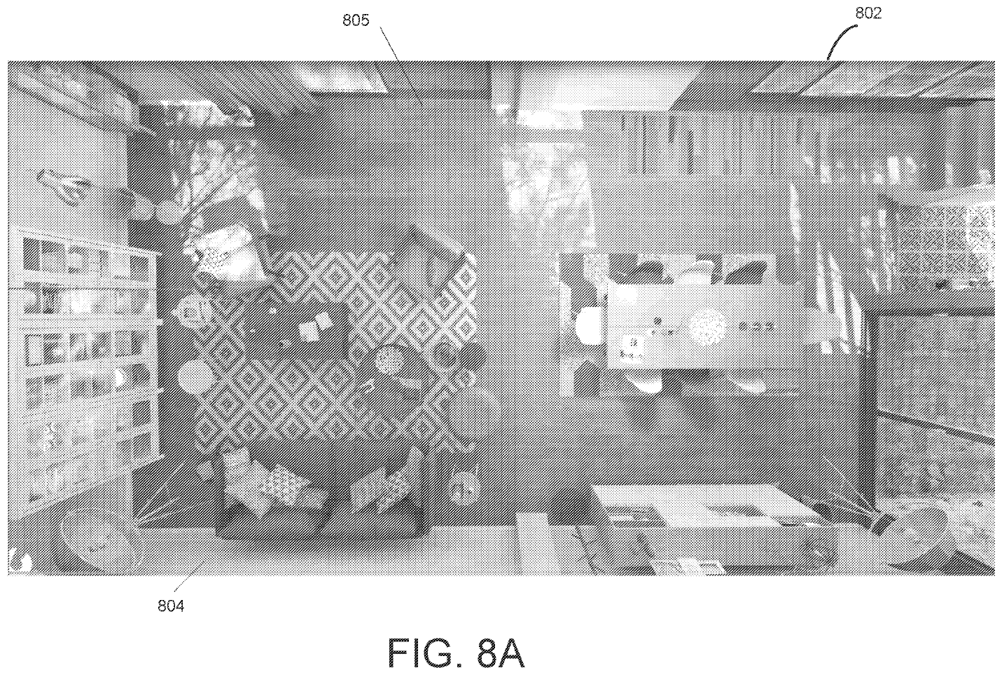

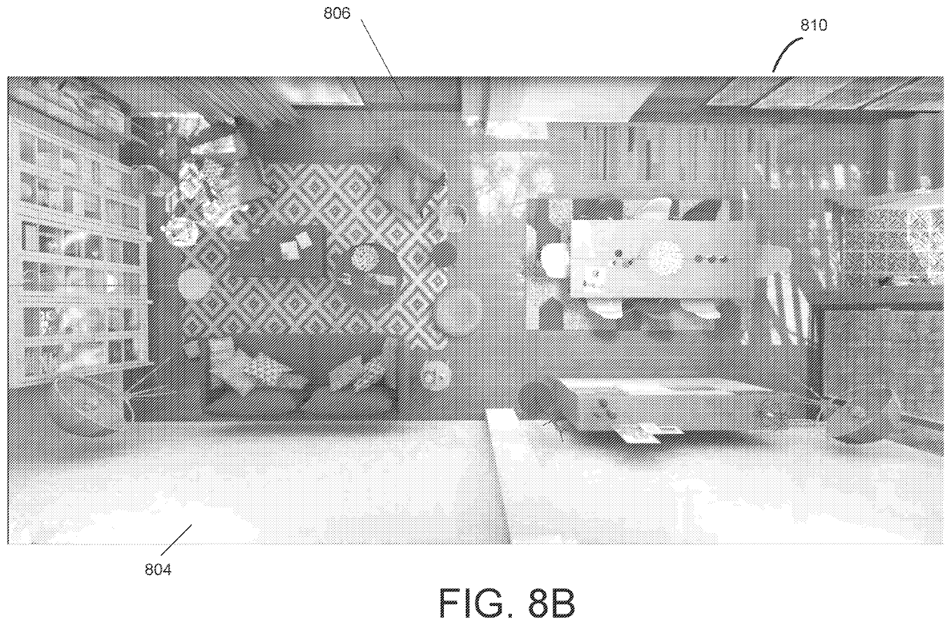

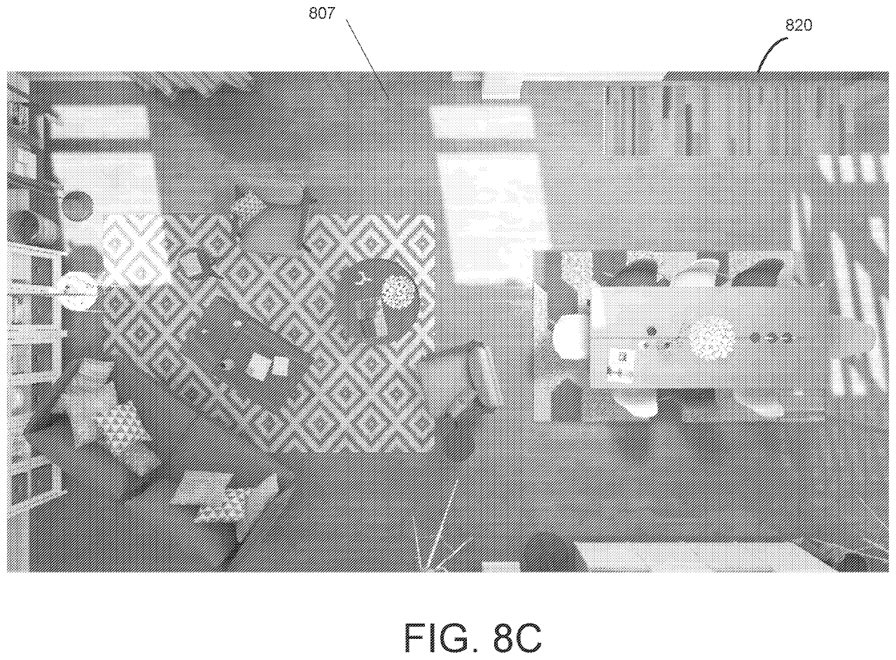

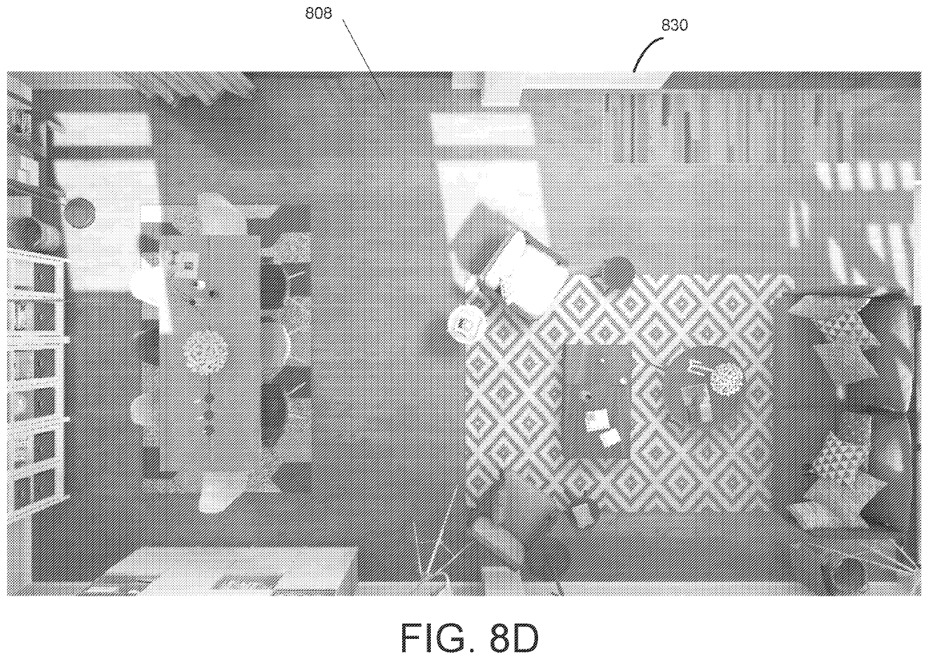

In act 316, user input indicative of one or more actions to perform with respect to the one or more visualizations (e.g., visualizations 606a, 606b, 606c, 606d, 606e, 606f) of the one or more spaces (e.g., spaces 607a, 607b, 607c, 607d, 607e, 607f) may be received through the interactive user interface. The one or more actions may indicate an update to be made to the digital representation of the property (e.g., digital representations of spaces of the property). An update to a digital representation of a space may include an update to spatial data and/or imagery associated with the space. In some embodiments, an update to the spatial data associated with the space may include an update to the dimensions of the space. For example, dimensions of the space may be updated in response to user input to manipulate a structural element (e.g., a wall) in the space, as described below in relation to FIGS. 8A and 8B. In some embodiments, dimensions of the space may be updated in response to user input providing the updated dimensions via the interactive user interface 600.

In some embodiments, an update to the spatial data may include an update to 3D data for the space (for example, updated and/or additional 3D data may be obtained by performing additional 3D scans of the space). An update to the spatial data may include an update to one or more positions of one or more objects in the space and/or an indication to add a new object in the space at a specified position. For example, user input to update the positions of furnishings and/or appliances in the space may be received. In some embodiments, the one or more actions may include actions to update positions of objects in the space through interactive user interfaces 802, 820, 830. As shown in FIGS. 8A, 8C, and 8D, the update represents a re-arrangement of a plurality of objects in the space. User input to manipulate structural elements and/or update positions of objects may be user input to manipulate visualizations of the structural elements (e.g., 2D or 3D representations of the structural elements) and/or update positions of visualizations of the objects (e.g., 2D or 3D representations of the objects).

In some embodiments, an update to imagery associated with the space may include an indication to change an existing image of the space to another image and/or an indication to include a new image of the space in the digital representation of the space. For example, changing an existing image may include changing the existing image to another image with better visual characteristics (e.g., lighting, resolution, etc.). As another example, changing an existing image may include changing the existing image to another image depicting changes in characteristics associated with the space (e.g., additional furniture in the space, rearrangement of existing furniture in the space, etc.).

In act 318, one or more visualizations of the space may be updated based on the user input received in act 316. Continuing with re-arrangement example above, a position of one or more of the structural elements (e.g., walls) and/or objects (e.g., furniture) in a visualization of a space may be updated by a user, for example, by selecting and moving the structural element(s) and/or objects within the visualization. For example, manipulation of wall 804 (e.g., movement of wall) in visualization 805 depicted via interactive user interface 802 of FIG. 8A may result in an updated visualization 806 to be presented via interactive user interface 810 of FIG. 8B. Also, manipulation of various objects (e.g., changing positions of objects) in visualization 805 of FIG. 8A may result updated visualizations 807, 808 to be presented via interactive user interfaces 820, 830 of FIGS. 8C and 8D.

In act 320, a determination may be made regarding whether additional user input with respect to the space is received. In response to a determination that additional user input with respect to the space is received, the process loops back to act 316 to perform further updates to the visualizations of the space. In response to a determination that additional user input with respect to the space is not received, a determination may be made regarding whether additional input with respect to a different space is received (e.g., a user selection of a different space in the interactive user interface 600). In response to a determination that additional user input with respect to a different space is received, the process loops back to act 314 to generate visualizations of the different space and perform updates to the generated visualizations. In response to a determination that additional user input with respect to a different space is not received, the process may end.

FIG. 3C is a flow diagram of an example process for accessing a digital representation of a property for collaboration between users of the system of FIG. 1, according to some embodiments of the technology described herein. In act 352, a first user may access a digital representation of a property using a first client computing device 104a, for example. A first interactive user interface, for example, interactive user interface 600, generated using the digital representation may be presented to the first user at the first client computing device 104a. In act 354, the first user may select a visualization of a space via the first interactive user interface. For example, the first user may select a visualization of space 606a (e.g., dining room) presented via first interactive user interface 600 of FIG. 6.

In act 356, user input indicative of one or more actions to perform with respect to the visualization of the space may be received through the first interactive user interface. The user input may indicate changes to positions of certain pieces of furniture in the space (e.g., changes to position of a couch, a table, and a lamp in the dining room). An updated visualization may be generated and presented to the first user through the first interactive user interface. In some embodiments, the digital representation of the property may be updated to reflect any updates made at the first client computing device 104a. In some embodiments, the spatial data, imagery, and/or information about the objects associated with a space in the digital representation of the space may be updated to reflect the updates made at the first client computing device 104a.

In act 358, user input to share the visualization (from act 354 without the updates) and/or updated visualization (from act 356 with the updates) may be received through the first interactive user interface. In response to this user input, a second interactive user interface may be generated for a second user different from the first user. The second interactive user interface may be presented to the second user at a second client computing device 104b. Generating the second interactive interface may include (1) generating a second visualization of the space (e.g., the dining room) using the spatial data, imagery, and/or information about objects associated with the space, and (2) causing the second interactive user interface to be presented to the second user.

In some embodiments, generating the second visualization may include incorporating the updates made by the first user into the second visualization. In some embodiments, generating the second visualization may include generating the second visualization using the updated digital representation of the property (e.g., updated spatial data, imagery, and/or information about the objects associated with the space).

In act 360, the second user may receive a notification (e.g., a message, alert, etc.) regarding the shared visualization. In act 362, the second user may provide information related to the content of the shared visualization. Input in the form of comments, messages, questions, recommendations, quotes, bids, estimates, and/or emojis may be provided by the second user. In act 364, the information provided by the second user may be communicated from client computing device 104b to client computing device 104a. The received information may be presented to the first user in the first interactive user interface.

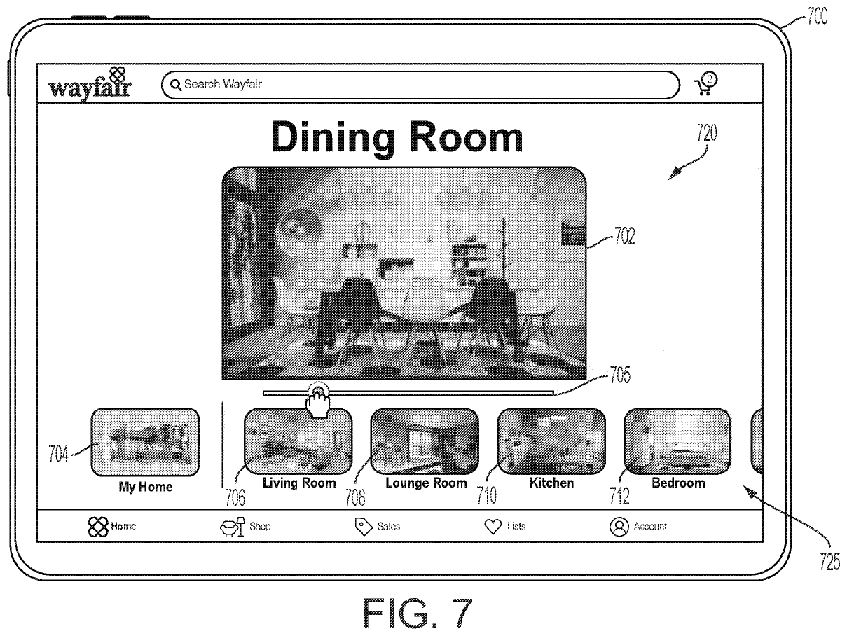

In some embodiments, selection of visualizations of spaces in a property may be performed via an interactive user interface presented to a user. FIG. 6 is an example screen capture of interactive user interface 600 that allows a user to view and interact with a digital representation 602 of a property, such as a home. The user may interact with visualizations 606a, 606b, 606c, 606d, 606e, 606f of spaces in the home, such as, spaces 607a, 607b, 607c, 607d, 607e, 607f, in the home, according to some embodiments of the technology described herein. Interactive user interface 600 may include a first portion 601 that displays the visualizations 606a, 606b, 606c, 606d, 606e, 606f. Interactive user interface 600 may include a second portion 603 that displays imagery associated with the multiple spaces 606a, 606b, 606c, 606d, 606e, 606f of the home. In some embodiments, visualizations and/or imagery associated with each of the spaces may be selectable by a user. For example, selecting a visualization of a space, such as space 606a (e.g., dining room) in the first portion 601, may cause an interactive user interface 700 (FIG. 7) to be presented. As another example, selection of an image of a space (e.g., an image with a partial view or full view of a dining room) in the second portion 603, may also cause the interactive user interface 700 to be presented.

In some embodiments, selection of the visualization and/or imagery presented via interactive user interface 600 may cause an expanded visualization of the space to be presented. For instance, selection of a visualization of a space 606e in the first portion 601 or selection of an image 620 of the space in the second portion 603, may cause an expanded visualization 808 of the space to be presented via interactive user interface 830 (FIG. 8D). In some embodiments, the expanded visualization may include expanded visualizations of the selection and/or of its adjoining spaces. As shown in FIG. 8D, the expanded visualization of the living room may include an expanded visualization of the dining room as well.

In some embodiments, interactive user interface 600 may include interface elements 608, 610, 612, 614, 616. These interface elements may allow a user to further interact with the interactive user interface 600. Selection of interface element 608 may cause the user to be navigated to the homepage. As shown in FIG. 6, interface element 608 is presented differently from the other interface elements (e.g., different color, different font style (e.g., bold)) indicating that the homepage is being presented.

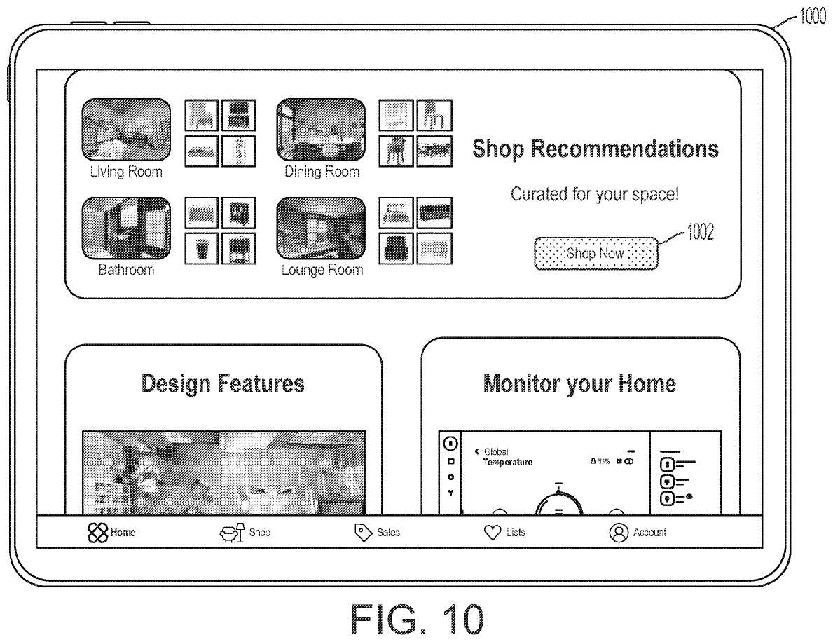

Selection of interface element 610 may cause an interactive user interface, such as, interactive user interface 1000 of FIG. 10 to be presented. The interactive user interface 1000 may enable a user to initiate a product browsing or shopping session. Selection of interface element 612 may cause information about various promotions or sales to be presented to the user. Selection of interface element 614 may cause information about personally curated lists of items/products or system recommended lists of items/products to be presented to the user.

In some embodiments, selection of interface element 616 may cause the user's account information to be presented. The user may be an authorized user (e.g., owner) of the account. The account information may be generated or provided during a registration process with the technology platform. The account information may include the user's name, address, contact information, payment information (e.g., credit card, bank account, etc.), information about pending or past purchases, information about pending or past service requests, information about warranties for existing objects in the home, and/or other information.

FIG. 7 is another example screen capture of an interactive user interface 700 that allows a user to view and interact with visualizations of digital representations of spaces in a home, according to some embodiments of the technology described herein. As shown in FIG. 7, interactive user interface 700 may include a first portion 720 that displays a visualization of a digital representation of a space 702, for example, dining room. The first portion 702 may include an interface element 705 (e.g., a slider) that when manipulated horizontally by the user, allows the user to navigate through the entire space.

The interactive user interface 700 may include a second portion 725 that displays imagery associated with multiple spaces of the home. The imagery associated with the spaces may be presented in the form of selectable image icons 706, 708, 710, 712. An icon, when selected by the user, may cause an interactive user interface including an expanded visualization of the space to be presented. For example, selection of icon 706 associated with the living room may cause an expanded visualization 808 of the living room to be presented via interactive user interface 830 (FIG. 8D). Selection of the home icon 704 may cause the user to be navigated to the homepage, for example, including the interactive user interface 600 of FIG. 6.

In some embodiments, an open-source data standard may be created to represent various aspects of a property—property as an entity (e.g., digital representation) that goes through various changes. This may be universal, trackable & verifiable (maybe using blockchains). In some embodiments, a standard may be created for a 3D piece of furniture, which would allow 3D products to be readily available via various search or technology platforms.

FIG. 3D shows an example process 380 for accessing and using a digital representation of a property. The process 380 may be performed using a computing device such as a server computing device 102 or any client computing device 104a, 104b, . . . , 104n described above with reference to FIG. 1. As shown in FIG. 3D, the process 380 comprises an act 382 of accessing a digital representation of a property; an act 384 of analyzing data in the property profile and/or user profile associated with the property; an act 386 of obtaining one or more visualization layers of the property; an act 387 of determining whether to generate a visualization of the property; an act 388 of generating a visualization of the property based on the one or more visualization layers in response to a determination to generate the visualization; and an act 389 of storing a version of the digital representation for subsequent access in response to a determination to not generate the visualization.

In act 382, a digital representation of a property 106a, 106b, 106c, . . . , 106n may be accessed. The digital representation of the property may be accessed via the technology platform App installed on client computing device 104a, 104b, . . . , 104n. The digital representation of the property may be accessed in response to a user request received via a user interface, for example, user interface 500. The user request may include an address associated with the property, a property identification number, location information associated with the property (e.g., latitude and longitude or GPS coordinates), and/or other information that identifies the property. In response to the user request, the digital representation of the property associated with the property identification information in the user request may be accessed. In some embodiments, accessing the digital representation of the property may include obtaining the digital representation of the property from server computing device 102. In some embodiments, accessing the digital representation of the property may include retrieving the digital representation of the property from memory associated with client computing device 104a, 104b, . . . , 104n.

In some embodiments, accessing the digital representation of the property comprises obtaining spatial data, imagery, and/or information about objects associated with one or more spaces of the property. In some embodiments, accessing the digital representation of the property comprises accessing the property profile and/or user profile associated with the property.

In some embodiments, the user request may include an indication of a type of access requested, for example, read access, write access, read and write access, admin access, and/or other types of access.

In act 384, data in the property profile and/or user profile associated with the property may be analyzed. Analyzing data in the property profile may include analyzing the spatial data, imagery, and/or information about objects associated with one or more spaces of the property. In some embodiments, imagery associated with a space of the property may be analyzed to identify objects (e.g., flooring, furniture, etc.) in the space and characteristics of the objects, such as, object type (e.g., couch, recliner, bookshelf, desk, chair, etc.), color, texture size, material of the objects, position of the object in the space, and/or other characteristics. Characteristics of the objects may be analyzed to determine style(s) (e.g., modern, contemporary, etc.) associated with the objects. Imagery associated with the space may be analyzed to identify characteristics of the space, for example, type of space (bedroom, kitchen, etc.), paint color used for surfaces or walls in the space, color of flooring in the space, texture and color of countertops, backsplashes, appliances, and/or other objects in the space. An overall style of the space may be determined based on characteristics of the space and/or characteristics of various objects in the space.

In some embodiments, images or 3D models of the identified objects and/or information about the identified objects may be compared with product information maintained in a database, such as product database 260. For example, an image or 3D model of an identified couch may be compared with one or more images or 3D models of couches in the product database and/or information about the identified couch may be compared with product information associated with one or more couches in the product database. In some embodiments, the comparison may be performed relative to products characterized as having the same style as the identified couch or the overall style of the space in which the identified couch is placed. In some embodiments, a determination may be made regarding whether the identified couch matches any products in the product database. In response to a determination that the couch matches a product in the product database, the 3D model or image of the matched product may be identified and used for generating visualizations of the property. In response to a determination that the couch does not match a product in the product database, a product closest or most similar to the couch is identified from the product database and the 3D model or image of that product may be used for generating visualizations of the property. For example, visualizations of a space may be generated by displaying a 3D model or image of a matched or most similar product in the visualizations instead of the identified couch. In some embodiments, visualizations of the space may be generated by replacing or substituting the identified couch in a digital representation of the space or visualization of the space with a 3D model or image of the matched or most similar product from the product database.

In some embodiments, analyzing data in the user profile may include identifying authentication information associated with a user requesting access and determining whether the user is authorized to access the digital representation of the property based on the authentication information. In some implementations, the user request may include information identifying the user, such as, authentication information including a username/id and password. This information may be compared against the authentication information stored in the user profile to determine whether the user is authorized to access the digital representation of the property.

In some embodiments, analyzing data in the user profile may include identifying the role, permissions, and preferences associated with the user requesting access to the digital representation of the property. This data may be analyzed to determine whether the user is permitted to access the digital representation of the property and the level or type of access permitted. For example, a current owner of the property may be authorized and granted full access (e.g., read, write, update, etc.) to the digital representation of the property at any time. A current vendor, such as a designer assisting with a kitchen remodeling project, may be authorized and permitted to access (read, write, update, etc.) the digital representation of the kitchen (and not other spaces of the property) for the duration of the project. A past vendor may not be authorized or permitted to access the digital representation of the property.

In some embodiments, a determination regarding whether the user is permitted to access the digital representation of the property may be made based on analysis of data in the user profile and the type of access requested. For example, a past vendor may request read and write access to update the digital representation of the property. Based on the analysis of data in the user profile indicating that this user is an inactive or past vendor who does not have permission to access (read or write access) the digital representation, a determination may be made that this past vendor is not permitted to access the digital representation of the property.

In some embodiments, process 380 proceeds to act 386 in response to determination(s) that the user requesting access to the digital representation of the property is authorized and permitted to access the digital representation.

In act 386, one or more visualization layers of the property may be obtained. In some embodiments, one or more visualization layers of the property or spaces of the property may be obtained based on the analysis of the data in the property profile and/or user profile. In some embodiments, obtaining the one or more visualization layers of the property may include identifying which visualization layers are to be used for generating visualizations of the property. Identifying visualization layers to use for generating visualizations of the property may be based on, for example, roles and/or permissions information associated with the user requesting access.

In some embodiments, the identification of visualization layers to use may be performed on a space-by-space basis. For example, a user requesting access to the digital representation of the property may be identified as a current vendor, such as a designer assisting with a kitchen remodeling project. This vendor may be permitted to access only the digital representation of the kitchen. Accordingly, one or more visualization layers associated with the kitchen may be obtained for generating visualizations for this vendor. As another example, a user requesting access to the digital representation of the property may be identified as a current renter. The renter may be permitted to access digital representations associated with multiple spaces of the property. Accordingly, one or more visualization layers associated with the multiple spaces of the property may be obtained for generating visualizations for the renter.

In some embodiments, the identification of visualization layers to use may be performed on a layer-by-layer basis. For example, roles and/or permissions information associated with users of the property may indicate which visualization layers of the property the users are permitted to access. For example, a current vendor, such as a designer, may be permitted to access visualization layers one, four, five, and six of the visualization layers shown in FIG. 4B. As another example, a current owner may be permitted to access all the visualization layers of the property. In some embodiments, permissions information associated with a user may indicate, for each visualization layer, the type of access permitted. Continuing with the current vendor example, read access may be permitted for visualization layers one and four whereas read and write access may be permitted for five and six.

In some embodiments, multiple user requests to access the digital representation of the property may be received. In response to the multiple user requests, multiple versions of the digital representation may be generated based on the respective roles and/or permissions of the users requesting access. For example, a first version of the digital representation of the property may be generated for a first user requesting access, a second version of the digital representation of the property may be generated for a second user requesting access, and so on. Each version of the digital representation may include visualization layer(s) associated with spaces that the requesting user is permitted to access. Continuing with the current vendor and renter examples above, a first version of the digital representation including visualization layers associated with the kitchen may be generated for the current vendor and a second version of the digital representation including visualization layers associated with multiple spaces of the property may be generated for the current renter. In some embodiments, the multiple user requests may be received simultaneously, around the same time, or at different times.

In some embodiments, obtaining the one or more visualization layers of the property may include generating one or more new visualization layers for the property based on the analysis of data in the property profile. For example, the digital representation of the property may include updated or new imagery of a space that may include new objects that were not present in earlier images of the space. Analysis of this imagery may result in identification of the new objects and one or more new visualization layers may be generated to enable visualization of these new objects. For example, a new rug may be identified in the living room and a new visualization layer associated with the living room may be generated to enable visualization of the new rug. In cases where a visualization layer associated with layered flooring exists for the living room, the existing visualization layer may be updated to include information about the new rug.

In act 387, a determination may be made regarding whether to generate a visualization of the property. In response to a determination to generate the visualization of the property, one or more visualizations of one or more spaces of the property may be generated in act 388. In some embodiments, the user may, by selecting an option provided via a user interface, provide a request to render or visualize the digital representation of the property. The one or more visualizations of the space(s) may be generated in response to such a request.

In some embodiments, the one or more visualizations of space(s) of the property may be generated based on the one or more visualization layers associated with the space(s) obtained in act 386. The visualizations may be presented via the interactive user interface, such as interface 600 of FIG. 6 as described herein. The visualizations presented in FIG. 6 may be generated using one or more visualization layers associated with each space 607a, 607b, 607c, 607d, 607e, 607f.

In some embodiments, each visualization layer associated with a space may include information that enables visualization of different aspects, components, or objects of the space. For example, one visualization layer may enable visualization of base flooring in the space whereas another visualization layer may enable visualization of objects in the space. A visualization generated for a first space may be generated using a first set of visualization layers and a visualization generated for a second space may be generated using a second set of visualization layers. For example, visualization 606b of space 607b may be generated using a group of visualization layers that include information about the shell of space, the layered flooring, the wallpaper, and the paint in the space. As another example, visualization 606c of space 607c may be generated using a group of visualization layers that include information about the shell of space, the layered flooring, the paint, and the objects in the space.

In some embodiments, the visualizations of the spaces may include visualizations of objects in the spaces. In some embodiments, generating the visualizations of the spaces may include generating visualizations of the objects using information about the objects in the respective spaces. For example, images of an object in the space may be compared with images of products maintained in product database 115. In response to a determination that the object image matches a product image in the product database, a 3D model or image of the matched product may be used for generating visualizations of the object in the space. In response to a determination that the object image does not match a product image in the product database, a product closest or most similar to the object is identified from the product database and a 3D model or image of that product may be used for generating visualizations of the object in the space. For example, visualizations of a space may be generated by displaying a 3D model or image of the matched or most similar product from the product database instead of the object.

In some embodiments, depending on the role and/or permissions of the user requesting access and the type of access requested, a read-only version or an editable-copy version of the digital representation may be visualized. In some embodiments, the one or more visualizations of space(s) of the property may be generated based on an editable-copy version of the digital representation. For example, a current vendor who is permitted to access a digital representation of a particular space may be provided with a visualization generated using an editable-copy version of the digital representation of that space. The information included in the editable-copy version of the digital representation may depend on the role and/or permissions of the user requesting access.

In some embodiments, in response to a determination to not generate the visualization of the property, version(s) of the digital representation may be generated and/or stored for subsequent access in act 389. For example, a current owner of the property may access the digital representation of the property to update the digital representation. The update may include an update to the imagery associated with one or more spaces of the property (e.g., when new imagery for the space(s) is generated or otherwise available such as when ownership changes), an update to object information associated with the space(s) (e.g., when a new object, such as an appliance or piece of furniture is purchased), an update to information in one or more visualization layers, and/or other updates. Information in the property profile and/or user profile may be updated to address these updates. For example, new imagery associated with the space may be stored in the property profile. In some embodiments, an updated version of the digital representation may be generated and stored in act 389. It will be appreciated that various analyses described in relation to acts 384 and 386 may be performed as part generating and storing version(s) of the digital representation. For example, identification of new objects in the space and comparison with products in the product database may be performed to generate an updated version of the digital representation that includes the 3D models or images of the matching/similar products instead of 3D models or images of the new objects.

### Use Cases

In some embodiments, a digital representation of a property may be used in various applications including shopping (e.g., shopping for products, like furniture, which may be purchased for use in the property), provisioning of services for the property (e.g., design services, contractor services, etc.), collaboration with individuals or third-party entities regarding visualizations of spaces of the property, and various other applications.

According to some embodiments, the interactive user interfaces described herein may be generated using the one or more digital representations of properties 106a, 106b, 106c, . . . , 106n. The interactive user interface may allow a user to perform one or more actions with respect to the multiple spaces in a property. The one or more actions may include updates to the digital representation of the property, actions related to shopping for products for the property, actions relating to re-arranging objects in the property, actions relating to collaboration with one or more other users (e.g., designers, contractors, contacts, service providers, etc.) or partner enterprises, and/or other actions. Examples of services or service providers may include assembly services, installation services (e.g., installation of electric and gas appliances, such as fireplaces, fire pits, laundry, etc.), annual maintenance or subscription services (e.g., air/water filters, winterization, window cleaning, hot tub/pool, etc.), light renovation or maintenance services (tile installation, cabinet installation, replacement of sink/toiler, painting), tech support (e.g., A/V, WiFi), medium renovation services (e.g., kitchen, bathroom, or roof renovation), cleaning services, large construction services (e.g., gut rehabs, new construction, etc.)

The various use cases below are described with respect to a digital representation of a home, however, it will be understood that the techniques described herein may be applicable to any type of property without departing from the scope of this disclosure.

### I. Update Digital Representation of Home

FIGS. 8A-8D are example screen captures of interactive user interfaces that allow a user to update digital representations of spaces in a home, according to some embodiments of the technology described herein. FIG. 8A illustrates an example interactive user interface 802 including a visualization 805 of a digital representation of a space. In this example, visualization 805 includes a view of adjoining spaces, for example, a living room and a dining room. User input to update the visualization 805 may be received through interactive user interface 802. For example, user input to move wall 804 (or other structural element of the room) may be received. In response to the user input to move wall 804 in visualization 805, an updated visualization 806 may be generated and presented via interactive user interface 810 of FIG. 8B. As can be seen in FIG. 8B, movement of wall 804 causes: i) the width dimension of the room to be reduced with respect to FIG. 8A and ii) causes various objects (e.g., couch, rug, armchairs, dining table and chairs, etc.) to be moved to accommodate the altered space. The updated visualization 806 is generated by updating visualization 805 to account for these changes.

In some embodiments, generating the updated visualization may include updating spatial data, imagery, and/or information about objects associated with the space. For example, generating updated visualization 806 for the living/dining room may include updating at least the spatial data (e.g., dimensions, positions of objects, etc.) associated with the digital representation of the living/dining room.

FIGS. 8C and 8D illustrate example interactive user interfaces 820, 830 that are presented in response to manipulation of one or more objects (e.g., changing positions of objects) in visualization 805 of FIG. 8A. For example, user input to change the position of or rearrange objects in visualization 805 may be received. In response to this user input, updated visualizations 807, 808 may be generated and presented.

In some embodiments, the system may provide various rearrangement options to the user. The system may generate various updated visualizations with objects rearranged in different positions in the space. The system may allow the user to browse through the options by “tapping” the screen. For example, a first tap may cause a first visualization including a first rearrangement of objects to be presented, a second tap may cause a second visualization including a second rearrangement of objects to be presented, and so on. The user may select one of the system-generated options or make his/her own changes to the objects in the space.

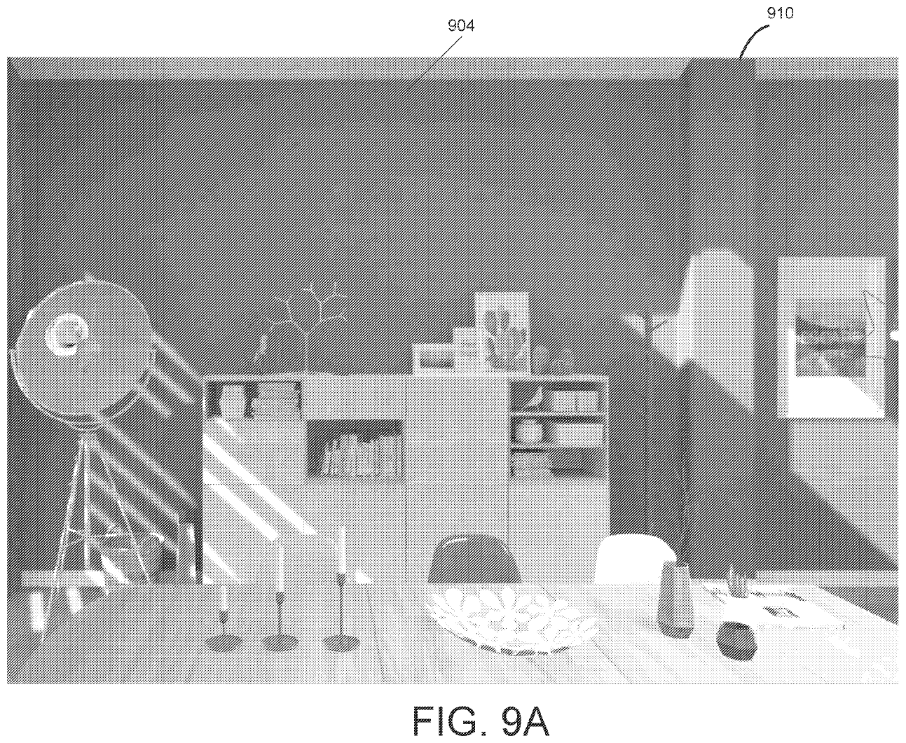

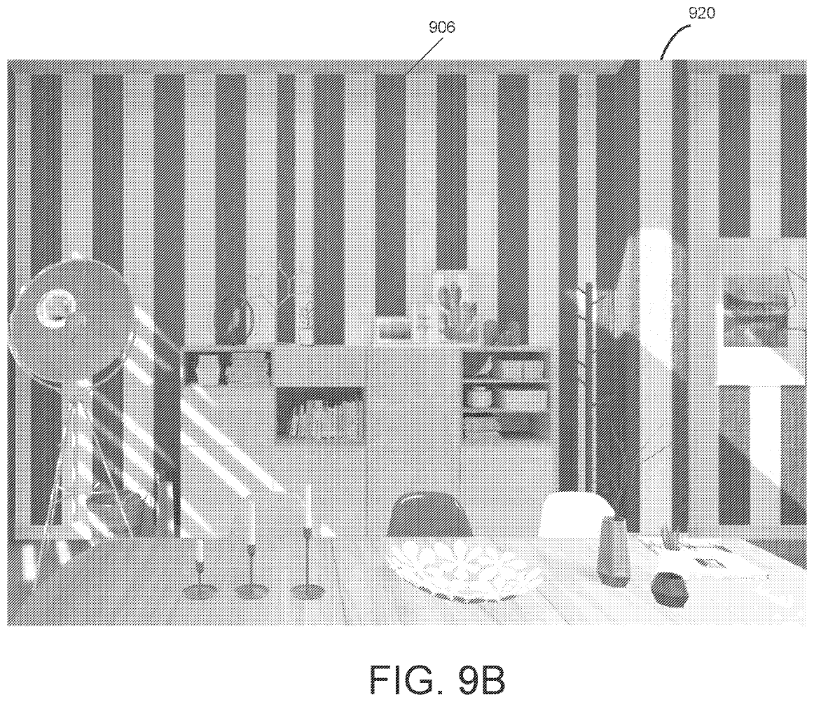

FIGS. 9A-9B are additional example screen captures of interactive user interfaces that allow a user to update digital representations of spaces in a home, according to some embodiments of the technology described herein. FIG. 9A illustrates an example interactive user interface 910 including a visualization 904 of a space. In this example, visualization 904 includes a partial view of the space (e.g., partial view of the dining room). User input to update the visualization 904 may be received through interactive user interface 910. For example, user input to change a wall covering for a wall in the space may be received. In response to the user input in visualization 904, an updated visualization 906 may be generated and presented via interactive user interface 920 of FIG. 9B. As can be seen in FIG. 9B, the updated visualization 906 depicts a different wall covering in comparison to visualization 904 of FIG. 9A.

In some embodiments, generating updated visualization 906 for the dining room may include updating at least the imagery (e.g., imagery including the wall covering) associated with the digital representation of the dining room. Various types of surface coverings (e.g., floor coverings) may be manipulated by the user to generate updated visualizations of spaces. Techniques for visualizing surface coverings within an image described in U.S. application Ser. No. 17/089,009 entitled “Systems and Methods for Visualizing Surface Coverings in an Image of a Scene,” may be utilized to generate updated visualizations and is incorporated by reference herein in its entirety.

In some embodiments, various updates to structural elements of the space, size of the space, objects in the space, views of the space may trigger generation of updated visualizations without departing from the scope of this disclosure.

### II. Use Digital Representation of Home for Home Furnishing, Shopping

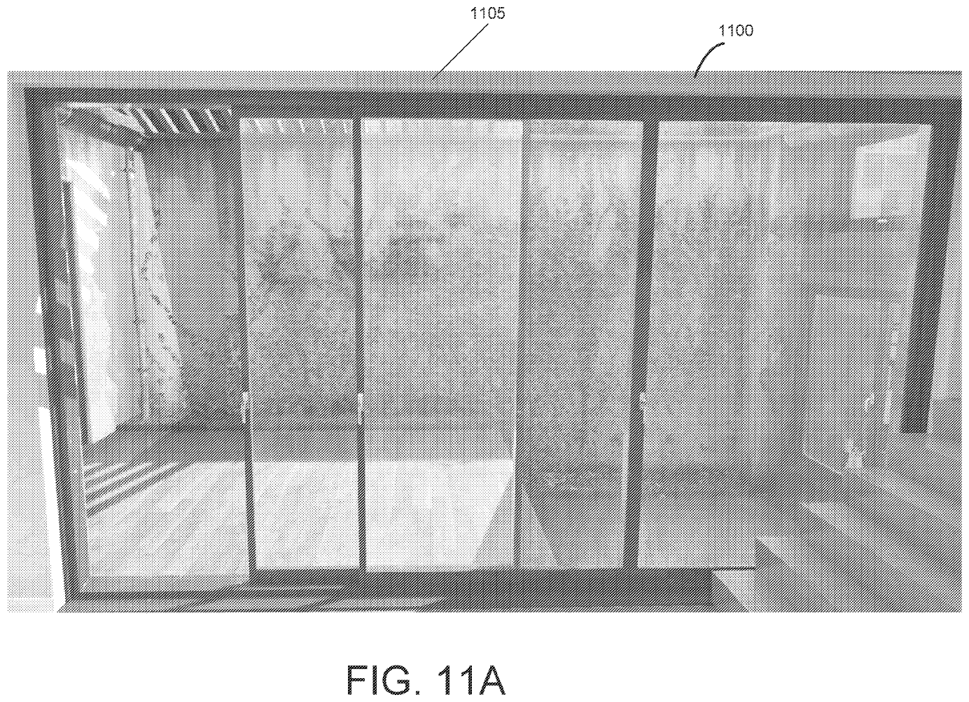

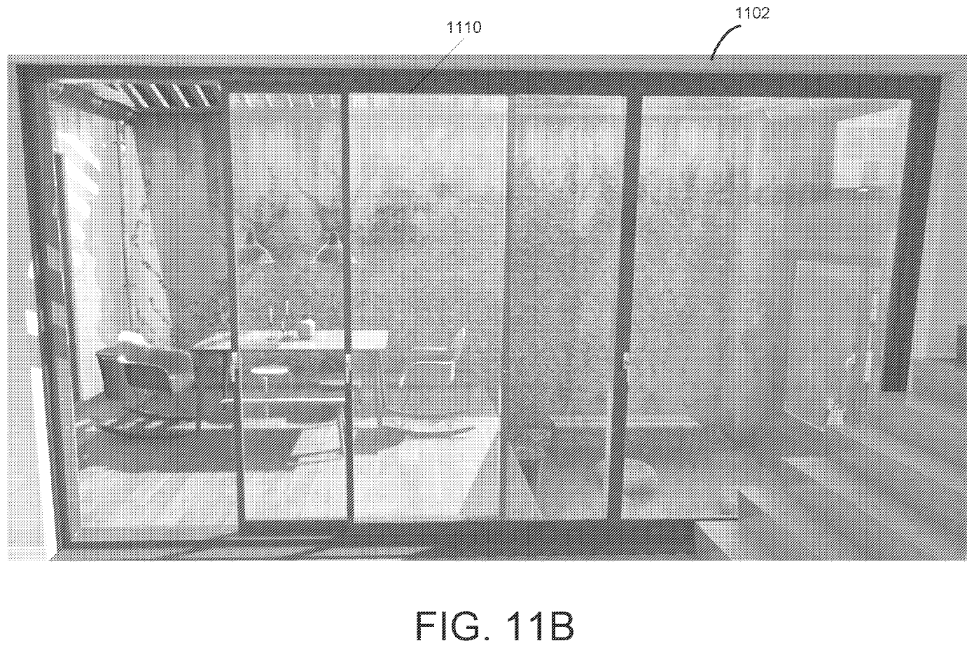

FIG. 10 is an example screen capture of an interactive user interface 1000 that allows a user to initiate a product browsing or shopping session, according to some embodiments of the technology described herein. Selection of interface element 1002 may cause the product browsing or shopping session to be initiated. In some embodiments, the user may indicate a space for which the user in interested in viewing products (e.g., furniture, wall art, etc.). For example, selection of space 607b causes interactive user interface 1100 of FIG. 11A that includes a visualization 1105 of the space to be presented to the user. As can be seen in FIG. 11A, the user may wish to furnish this space and shop for products for the space. The digital representation of the space may be used to virtually furnish the space, for example, furnish the space with virtual furniture (e.g., visualizations of furniture) from an online product catalog. The online product catalog may include 3D models of products. The system may, based on information from the digital representation (e.g., dimensions, images, floor plan, user preferences, etc.) and information from the 3D product catalog (e.g., SKUs, price, 3D product models), determine one or more products that can be used to furnish the space. The system may generate an updated visualization 1110 indicating the furnished space that includes various pieces of virtual furniture placed in various positions in the space.

In some embodiments, the system may automatically select products for furnishing the space based on information from the digital representation of the space and the 3D product catalog. In other embodiments, the system may allow a user to browse through various products in the catalog and generate the updated visualization based on information from the digital representation of the space and product(s) selected by the user.

In some embodiments, the system may utilize information about the digital representation of the space to automatically generate recommendations about layout changes for the space. In some embodiments, the system may generate one or more options for layout changes in response to a user request. For example, a user may request ideas about how best to design the space and/or flow of the home. In response, the system may generate various options (e.g., visualizations of the space) including updates to positions of existing objects in the space, addition of new objects (e.g., from a 3D product catalog) and/or removal of existing objects in the space. As another example, a user may request ideas about how to rearrange a space to host an event, such as a party including a certain number of people (e.g., 5 people, 10 people, etc.). In response, the system may generate various options (e.g., visualizations of the space) including updates to positions of existing objects in the space, addition of new objects (e.g., from a 3D product catalog) and/or removal of existing objects in the space.

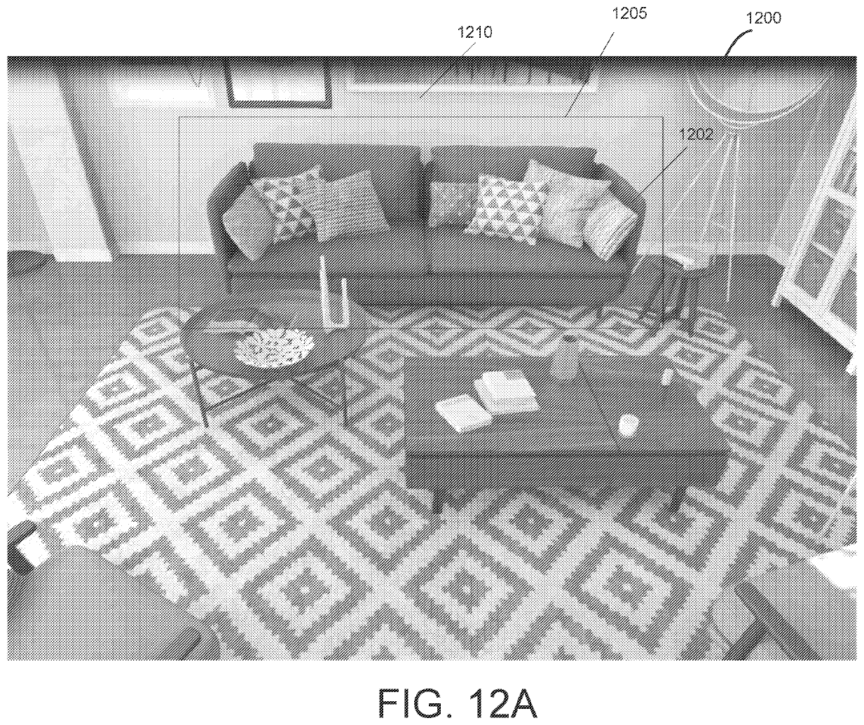

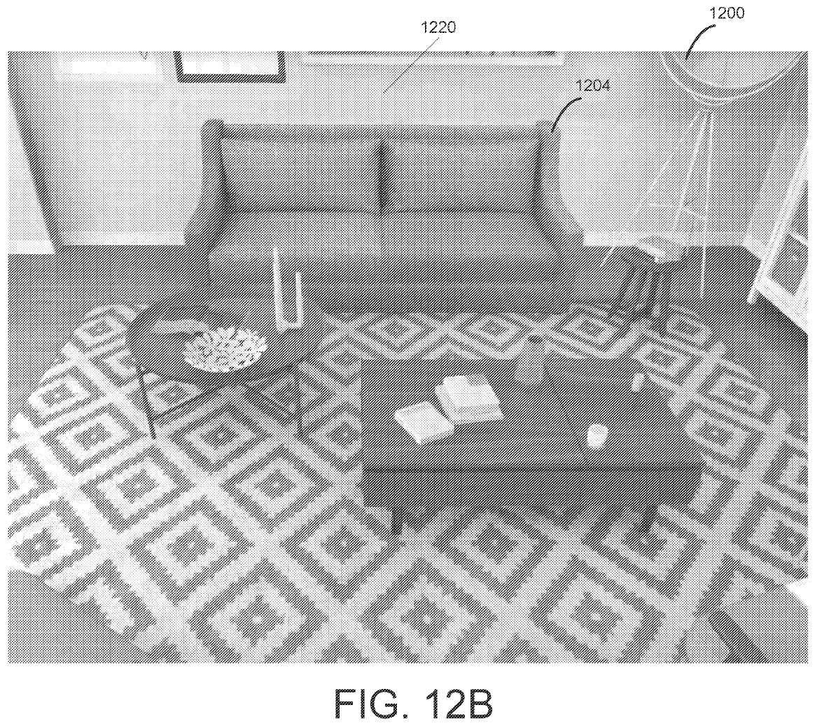

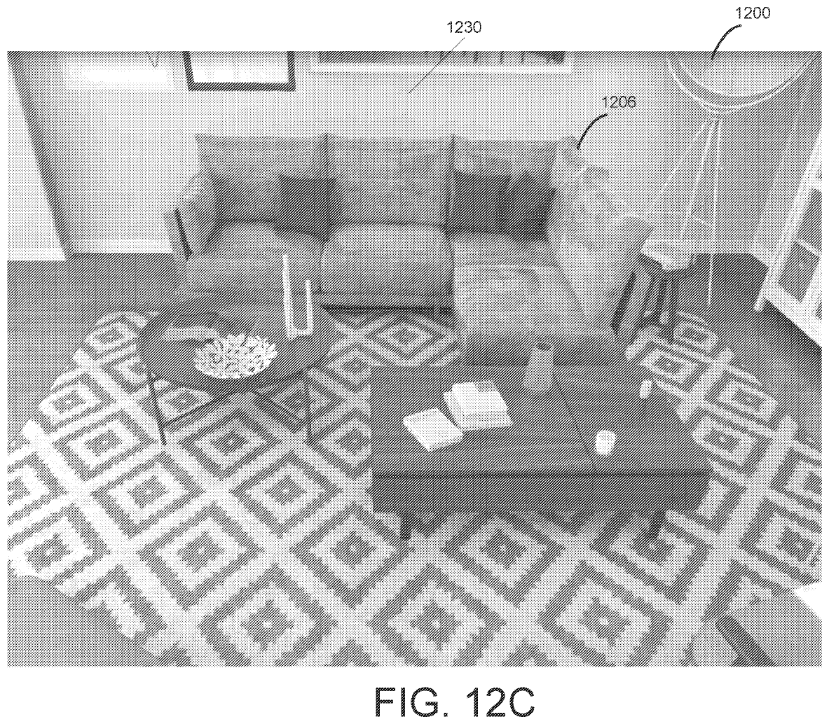

FIGS. 12A-12C are example screen captures of interactive user interfaces that allow a user to visualize different products at a same position in a visualization of a space of a home, according to some embodiments of the technology described herein. FIG. 12A illustrates an interactive user interface 1200 that includes a visualization 1210 of a space (e.g., a living room). In some embodiments, the interactive user interface 1200 may include a product browsing interface 1205 that allows a user to see information about one or more products in the space. For example, the user may wish to browse through couches for a particular position in the space. User input indicating a first couch and a position in visualization 1210 at which to insert a visualization (e.g., 3D model) of the first couch may be received. In response to the user input, the visualization may be updated to include the visualization of the first product (e.g., 1202) at the selected position.

The product browsing interface 1205 may allow the user to browse through products within the interactive user interface, for example, by swiping through the products in the space. User input in the form of a swiping motion (or other type of motion) may be received in the product browsing interface 1205. The swiping motion may cause alternative couch options to be presented to the user within the interactive user interface. For example, FIG. 12B illustrates interactive user interface 1200 with updated visualization 1220 generated in response to a first swiping motion, where the updated visualization 1220 includes a visualization of a second couch 1204 at the same selected position. Similarly, FIG. 12C illustrates interactive user interface 1200 with updated visualization 1220 generated in response to a second swiping motion, where the updated visualization includes a visualization of a third couch 1206 at the same selected position.

In some embodiments, the products options presented to the user via the product browsing interface 1205 may be identified and recommended to the user by the system. The system may utilize algorithms that power product search and recommendation based on user data (e.g., data known about the user) and/or home data (e.g., data associated with the digital representation of the home). The user data may be obtained from user profile 204 of the digital representation. The user data may be obtained from user's browsing history associated with the usage of the technology platform, demographic information obtained from third parties, and/or browsing behavior gleaned from cookies used by partner enterprises. The home data may include the spatial data, imagery and/or information about objects associated with the home/spaces of the home. In some embodiments, utilizing the home data may enable context aware and spatially aware computer vision powered search and recommendations. For example, a user may be looking to replace a couch, for example, couch 1202 in FIG. 12A. The system may perform a search for alternative couch options from the product catalog and filter the search results based on the user data and the home data (including data associated with the space, such as dimensions of the room, location of one or more other objects in the room, style of one or more objects in the room, etc.). Utilizing the home data allows the system to filter the search results (e.g., narrow down the search results) to include products that will fit in the space, fit in specified position (in the space) that the couch is in, match the style of the space that the couch is in, other products in the room, and/or other aspects of the home/space. The inventors improved existing product search and recommendation algorithms to utilize information about the user and information associated with the digital representation of the home to filter search results.

In some embodiments, the user may be looking to furnish a space and may be provided with recommendations on various pieces of furniture that may fit in the space as described in relation to FIGS. 11A-11B. The user may be provided with an ability to request to view the recommendations in their space. In response to the user request and using the digital representation of the home and/or other information collected about the home, the user may be presented with a visualization of the virtual furniture recommendations in their space.

The inventors have recognized that users typically shop for products in-context of their space (e.g., a dining table for the dining room, an armchair for the living room, an oven for the kitchen, a swing set for the porch, etc.). To enhance the user's shopping experience, the system may track the space that the user is shopping for, keep the digital representation of the space as a reference throughout the browsing session for the space, and serve up visualizations of the products in the space using the digital representation of the space. The system may provide the user with an option to see a personalized view of the product in the space.

In some embodiments, utilizing the home data for product search and recommendations may include utilizing spatial data and/or imagery associated with other spaces of the home. For a user looking to replace a couch in the living room, the system may generate a list of options including couches that fit in the space that the existing couch is in. The inventors have recognized that additional factors may need to be considered when identifying alternative couch options that fit in the space. For example, a determination may need to be made regarding whether a replacement couch fits through doors and/or hallways leading to the living room. In this regard, the inventors further improved the product search and recommendation algorithms to utilize information associated with digital representations of other spaces (e.g., dimensions of hallways, entryways, doorways, corridors, entrances, stairways, etc.), information associated with means of ingress and/or egress for entering and/or exiting the space (e.g., doors, windows), and/or information associated with other structural elements of the home to filter the search results.

In some embodiments, a style associated with objects in the space may be determined based on information associated with the digital representation of the space. For example, various image processing techniques may be applied to imagery associated with the space to identify objects in the space. Characteristics of the objects may be analyzed to determine style (e.g., modern, contemporary, etc.) associated with the objects. The product search and recommendation algorithms may filter the search results based on the determined style.

In some embodiments, the product search and recommendation algorithms described herein may generate recommendations for a space based on a combination of factors. In some embodiments, product recommendations for a space may be based on one or more of the following factors: i) spatial data associated with the space; ii) category or type of the space; iii) characteristics of the space; iv) characteristics of objects in the space; and v) user data (e.g., user preferences). For example, certain product recommendations for a space may be made based on the type of space (e.g., recommending garden tools for a solarium or cribs for a nursery). As another example, certain product recommendations for a space may be made based on the type of space and characteristics of the space (e.g., recommending lighter furniture for a space with darker floors or recommending certain color wall art for a space based on the paint color of walls in the space). As yet another example, certain product recommendations for a space may be made based on the characteristics of the space and characteristics of objects in the space (e.g., recommending silver appliances for a space that already includes other silver appliances or recommending certain color countertops based on the color and texture of backsplashes and appliances in the space).

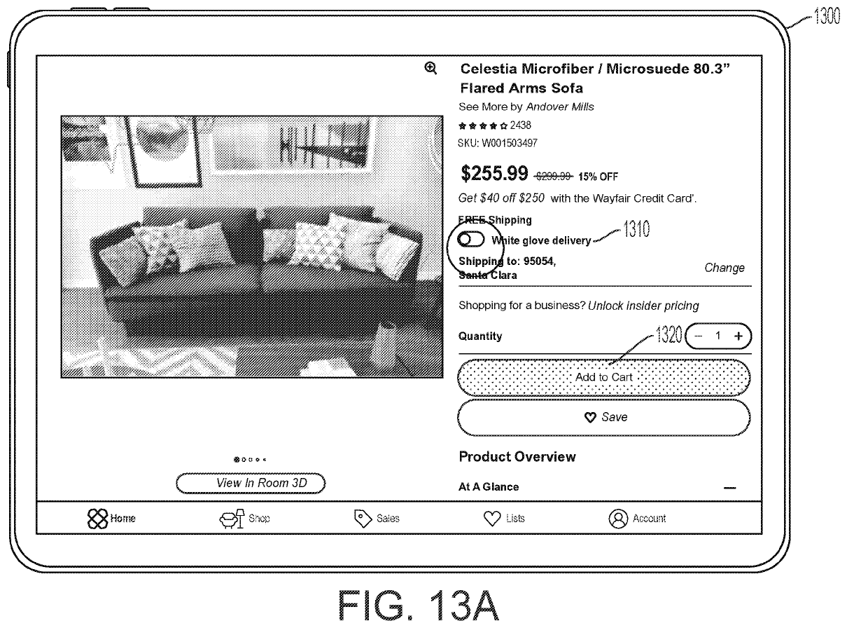

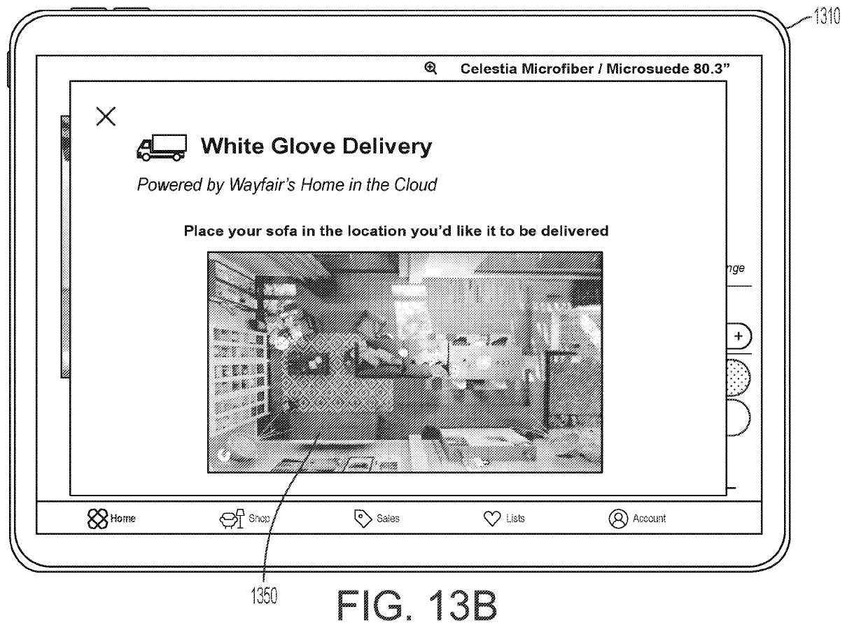

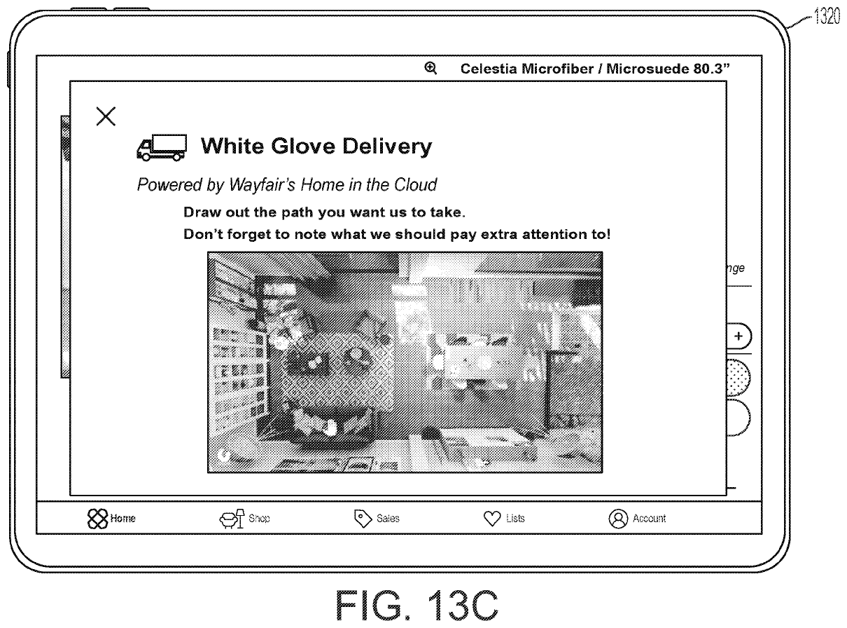

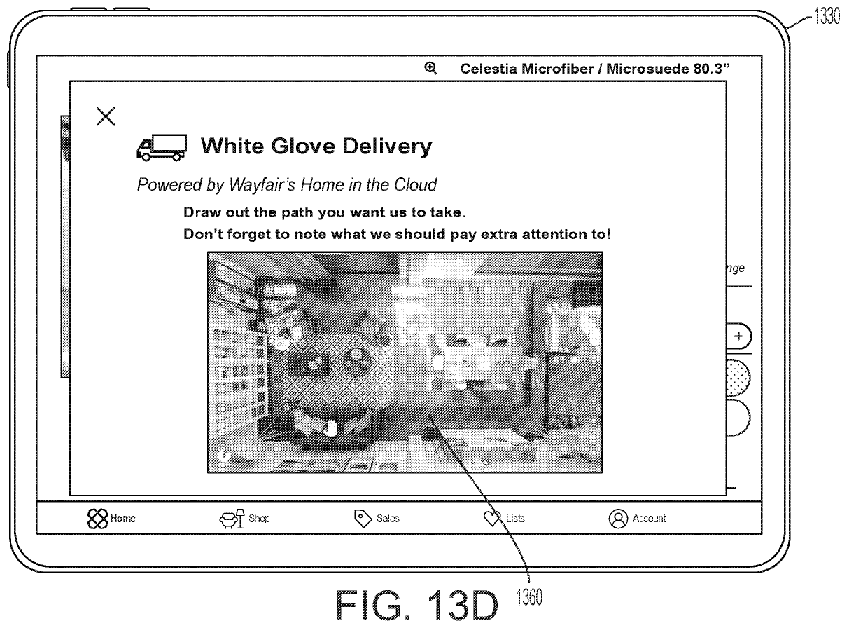

FIGS. 13A-13D are example screen captures of interactive user interfaces that allows a user to purchase a product, indicate a location in a visualization of a space in a home at which to position the purchased product, and indicate a delivery path through the home for the purchased product, according to some embodiments of the technology described herein.

FIG. 13A illustrates an interactive user interface 1300 that allows a user to purchase a product. For example, after browsing through various product options determined by the system, the user may select a particular product for purchase. The interactive user interface 1300 allows the user to confirm pricing and select delivery options. For example, interactive user interface 1300 may include interface element 1310 (e.g., toggle) that allows a user to select whether white glove delivery is desired. The user may indicate an intent to purchase the product by selecting interface element 1320.

As shown in FIG. 13A, the user has indicated that white glove delivery is desired. In this case, selection of interface element 1320 may cause the system to present FIGS. 13B-13D sequentially prompting the user to indicate a position in a space at which to place the product when the product is delivered to the home and to indicate at least a part of a path through the home that the product is to be moved through in order to be delivered to the home and placed at the indicated position in the space. For example, user input indicating the position 1350 in a space at which to place the product when the product is delivered to the home may be provided through interactive user interface 1310 (FIG. 13B). User input indicating the path 1360 through the home may be provided through interactive user interfaces 1320, 1330 (FIGS. 13C, 13D).

In some embodiments, a set of reference images/information about the home may be made available to the user at any location (e.g., when shopping at a retail location). For example, having access to the digital home representation and being able to measure dimensions of spaces in the home at any location would make for a better shopping experience. Such access may not be limited to just spatial data, but also other home data stored in the digital representation (e.g., information about aesthetics (e.g., furnishings, paint, etc.), appliances, electric system, plumbing system, HVAC system, structural elements, landscaping, geographics, etc.).

### III. Use Digital Representation of Home for Collaboration

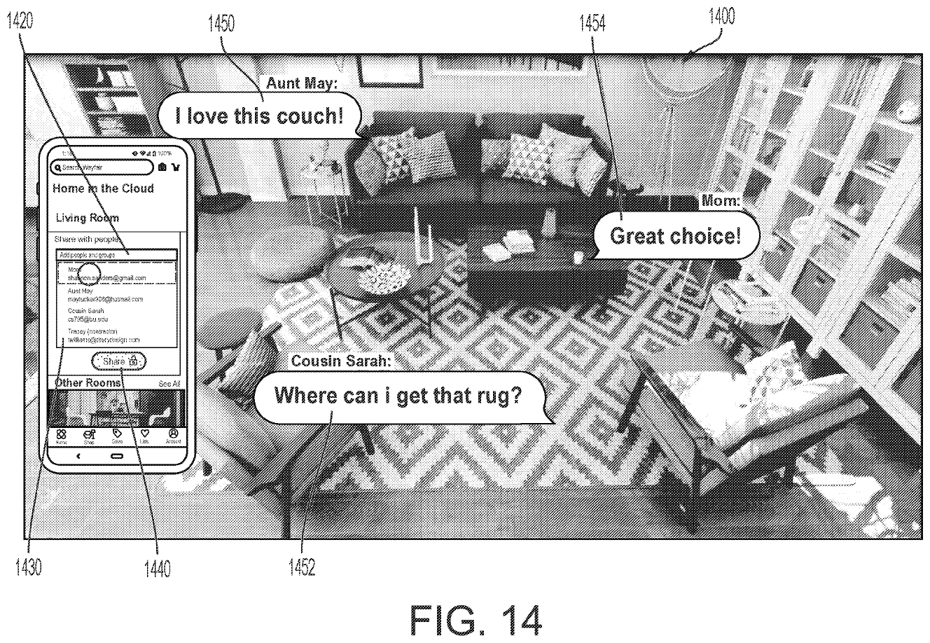

FIG. 14 is an example screen capture of an interactive user interface that allows a user to collaborate with other users of the system, according to some embodiments of the technology described herein. FIG. 14 illustrates an interactive user interface 1400 that presents information (e.g., comments, messages, questions, etc.) received from a second user as described in relation to FIG. 3C above. For example, a first user may share a visualization of a space with one or more second users. The first user may select the one or more second users via interface elements 1420, 1430, 1440. For example, user selection may be received via a drop-down menu including a list of contacts associated with the first user (e.g., obtained from the user profile). The selected second user(s) may provide information related to the content of the shared visualization and the shared visualization may be updated to reflect the received information. FIG. 14 illustrates comments 1450, 1452, 1454 received from three users (other than the first user) that the visualization was shared with. In some embodiments, the first user may utilize a first computing device to share the visualization and each second user may utilize a respective second computing device to provide comments regarding the shared visualization.

In some embodiments, visualization of spaces generated using digital representations of the spaces may be utilized for collaboration with various service providers (e.g., contractors, virtual staging services, designer services, etc.). For example, a first user may share visualizations of a space (e.g., the first user's living room) with a virtual staging service. User input to share the visualization may be received through a first interactive user interface at a first client computing device associated with the first user. In response to this user input, a second interactive user interface may be generated for a second user different from the first user (e.g., the second user associated with the virtual staging service). The second interactive user interface may be presented to the second user at a second client computing device different from the first client computing device. Generating the second interactive interface may include (1) generating a second visualization of the space (e.g., first user's living room) using the spatial data, imagery, and/or information about objects associated with the space, and (2) causing the second interactive user interface to be presented to the second user at the second client computing device.

In some embodiments, the second user may provide, at the second client computing device, input indicative of an action to perform with respect to the second visualization. The action may include one or more of: an update to one or more positions of one or more pieces of furniture, fixtures, and/or appliances in the first user's living room, an addition of a new piece of furniture, a new fixture, and/or a new appliance in the first user's living room at a specified position, an update to one or more wall coverings or floor coverings in the first user's living room, and an update to a color of one or more walls in the first user's living room. For example, the second user associated with the virtual staging service may stage various pieces of furniture in the first user's living room.

In some embodiments, input (e.g., the updates with respect to addition of new pieces of furniture) provided by the second user may be obtained at the first client computing device (e.g., communicated from the second client computing device to the first client computing device). The visualization of the first user's living room at the first client computing device may be updated to reflect these updates. In some embodiments, the visualization of the first user's living room at the first client computing device may be updated at least in part by performing action(s) indicated in the input provided by the second user.

In some embodiments, an updated second visualization may be generated at the second client computing device based on input from the second user. The updated second visualization may be provided to the first client computing device and presented to the first user in the first interactive user interface.

In some embodiments, various back and forth communications may be performed between the first user/first client computing device and the second user/second client computing device without departing from the scope of this disclosure. For example, a first user may collaborate with a designer service, where a designer (second user) may suggest changes to a visualization of a space and communicate the changes and/or updated visualization to the first user, the first user may communicate feedback regarding the changes to the designer, the designer may perform further updates to the visualization and communicate the changes and/or updated visualization to the first user, and so on.

In some embodiments, multiple versions of the digital representation of the property may be generated to enable collaboration between the first user, friends or family of the first user, and/or the second user (e.g., designer). For example, a designer may suggest a first design with a first set of changes to a space or objects in the space and a second design with a second set of changes to the space or objects in the space. Two versions of the digital representation of the property may be generated, each including the respective changes suggested by the designer. These two versions may be generated by branching the “true” version of the digital representation and allowing changes to be made to each branch. The first user, after receiving the two versions, may share the versions with friends or family to obtain their feedback regarding the changes. Based on the received feedback, the first user may select one of the two versions and communicate the selection to the designer. In some embodiments, crowdsourcing contests may be used to identify a particular branch/version as the selected design. It will be appreciated that any number of versions may be generated and coexist at the same time as aspects of the technology described herein are not limited in this respect.

In some embodiments, the techniques described herein may be used to add virtual furniture to a 3D-tour of a home put up for sale, to generate photorealistic renders of rooms staged with virtual furniture, to work with contractors to plan additions, renovations, or other changes to the home including receiving bids for the project, and/or other applications.

In some embodiments, information collected about the home (e.g., 3D model and/or other information) may be provided to various service providers as and when services are needed. The service providers may bid on the services, thereby reducing the burden on homeowners to find and line up service providers or contractors.

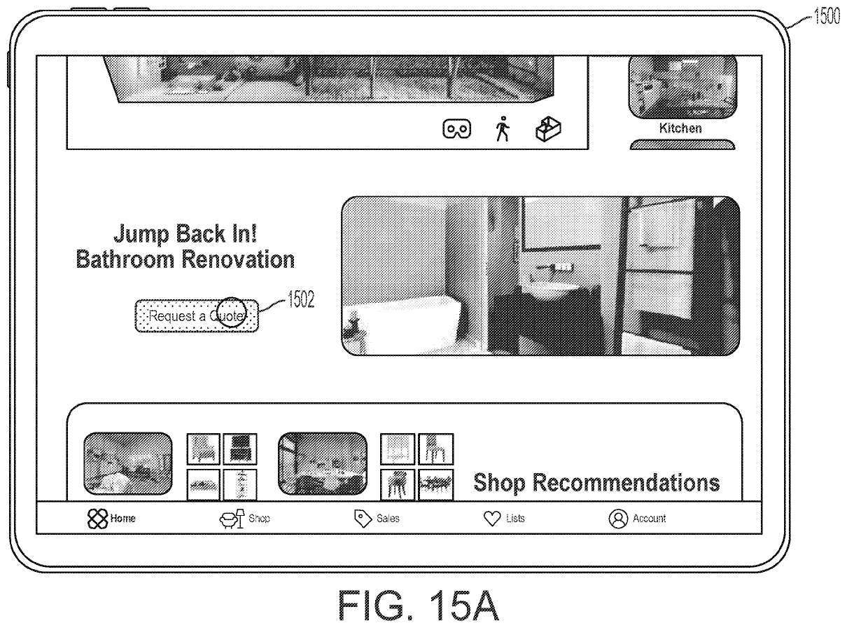

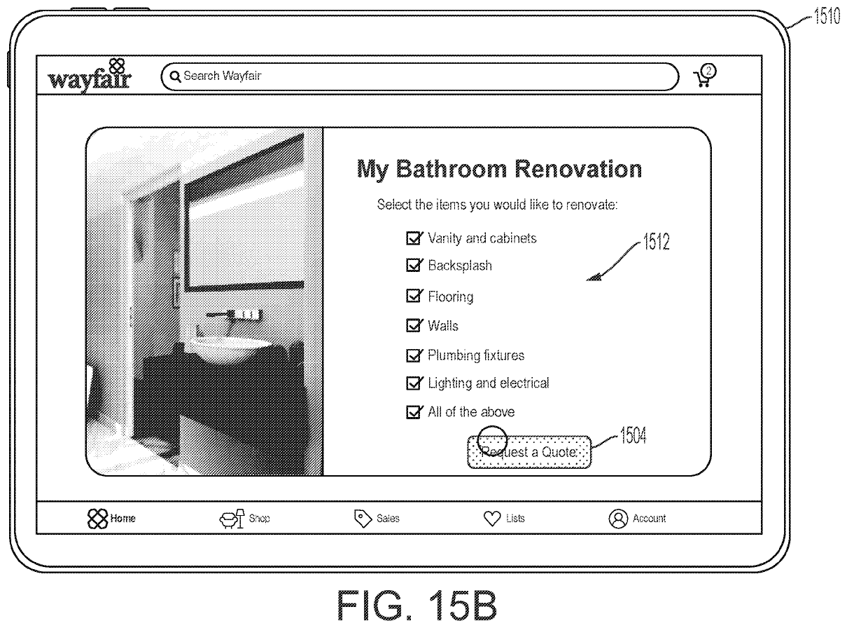

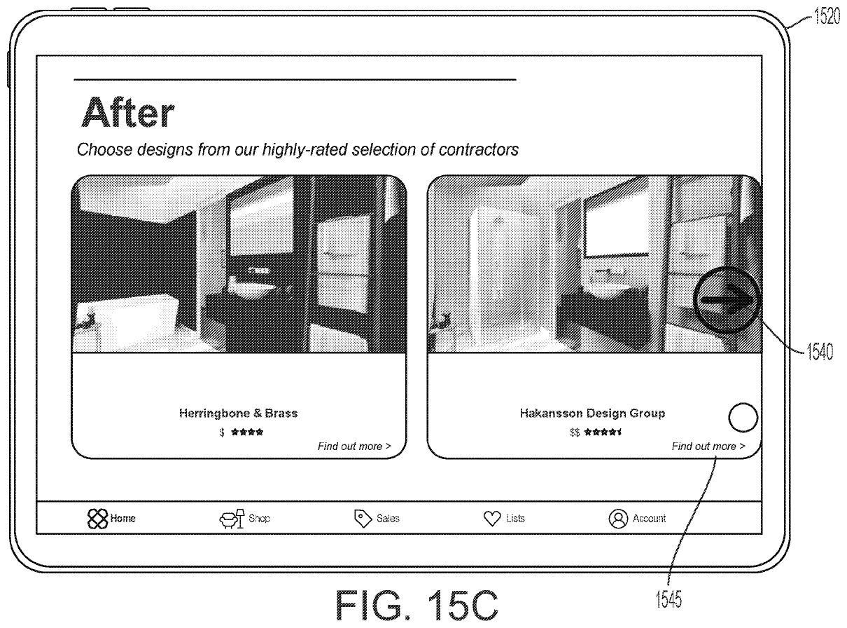

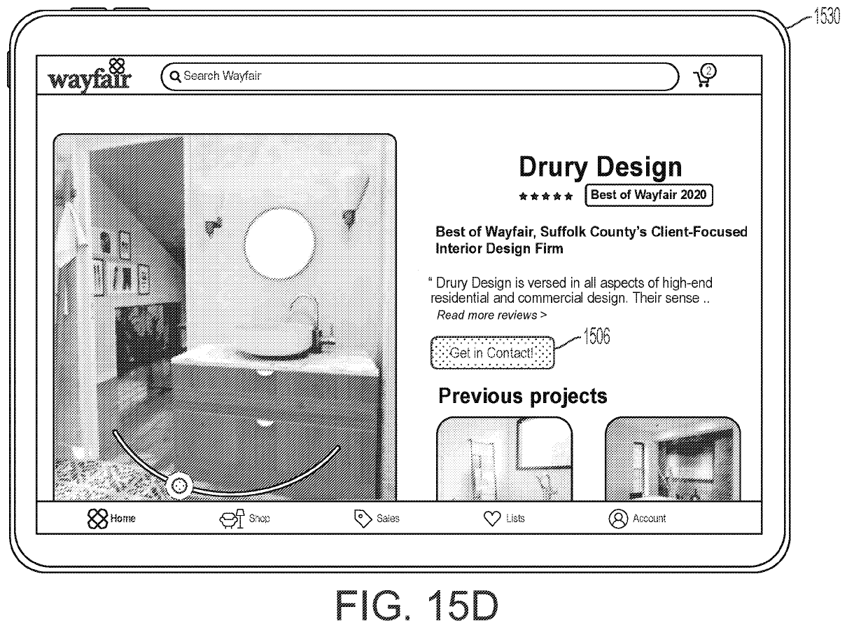

FIGS. 15A-15D are additional example screen captures of interactive user interfaces that allow a user to collaborate with other users (e.g., contractors) of the system, according to some embodiments of the technology described herein. FIGS. 15A-15B illustrate interactive user interfaces 1500, 1510 that allow a user to request quotes for a particular renovation project (e.g., a bathroom renovation). For example, interface elements 1502, 1504, 1512 may allow selection of items that the user wishes to renovate and trigger a request for a quote. FIGS. 15C-15D illustrate interactive user interfaces 1520, 1530 that present one or more design options offered by one or more contractors and allow the user to select a particular design option. The design options to be presented may be determined based on selections provided by the user in FIG. 15B, for example. The design options to be presented may be determined based on the quotes received from the contractors. In some embodiments, design options associated with all the contractors who provided a quote may be presented to the user (via interactive user interface 1520, for example). In some embodiments, the design options presented to user may be filtered based on the preferences (e.g., budget preferences) associated with the user obtained from the user profile. For example, only design options associated with contractor(s) who provided a quote falling with the user's budget preferences may be presented in interactive user interface 1520, for example.

In some embodiments, the user may browse through the various design options by interacting with interface element 1540. Selecting interface element 1545 may cause detailed information about a particular contractor to be presented to the user. FIG. 15D shows an interactive user interface 1530 including information about the contractor “Drury Design”. The user may read reviews for the contractor, view previous projects completed by the contractor and/or utilize other information about the contractor to determine whether the user is interested in contacting the contractor to initiate a discussion regarding the renovation project. The interactive user interface 1530 may include interface element 1506 that allows a user to obtain the contractor's contact information. In some embodiments, the system may facilitate collaboration between the user and the contractor, for example, by facilitating back and forth communication regarding visualization of spaces as described herein.

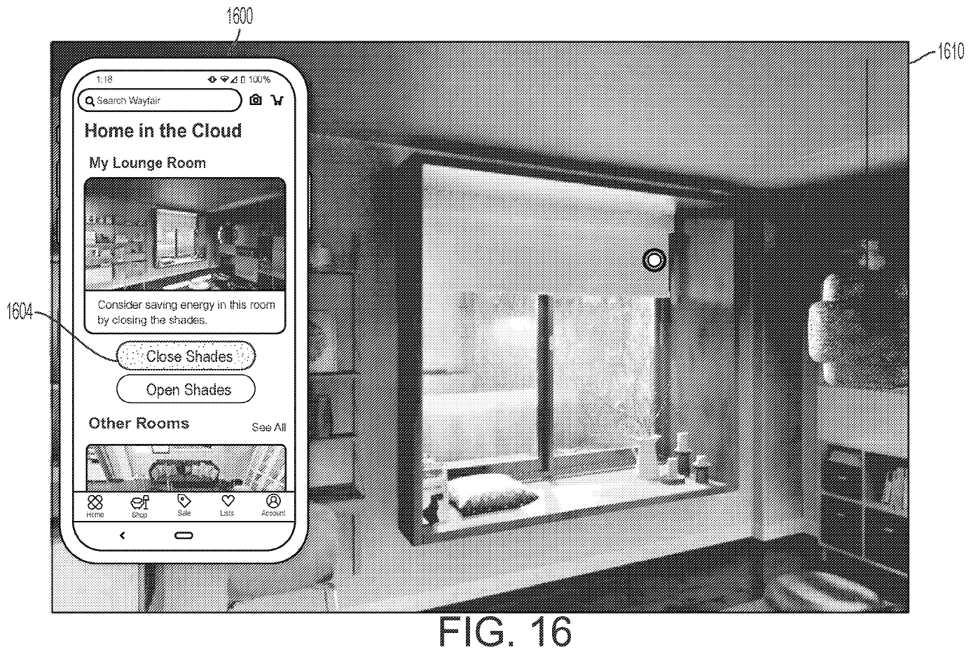

FIG. 16 is an example screen capture of an interactive user interface that allows a user to collaborate with partner enterprises, according to some embodiments of the technology described herein. For example, third-party partner enterprises may obtain information regarding the home (e.g., at least some of the information from the digital representation of the home) to provide insights, predictions, recommendations to the user. Such feedback may trigger actions taken by the user. For example, an energy assessment from a third-party partner enterprise may cause the user to make utility adjustments to improve the energy efficiency of the home. In some embodiments, interactive user interface 1600 may be generated in response to feedback regarding current energy usage of space 1610 (e.g., lounge room). For example, the feedback may include feedback regarding keeping the shades in the space closed during certain times of the day. An alert to close the shades may be generated and presented to the user in response to the feedback. Selection of interface element 1604 by the user may cause the shades in the room to be closed. In some embodiments, the system may interact with various smart home devices based on information from third-party partner enterprises.

In some embodiments, the system may utilize machine learning techniques to analyze patterns in data (e.g., analyze energy consumption trends) and provide insights and predictions to the user. For example, insights into energy efficiency may be provided along with a recommendation regarding ways of improving efficiency (e.g., by using solar, high efficiency HVACs, tankless water heaters, better home layout, energy efficient appliances, radiant heating, etc.).

In some embodiments, third-party partner enterprises may obtain information regarding the home to provide recommendations regarding system installations (e.g., speaker layout for a sound system installation, lighting design and layout for a lighting system installation, layout, and coverage of sprinkler heads for an irrigation system installation, etc.)

In some embodiments, third-party partner enterprises, such as home automation solutions, may play a role both as a provider of data about a home (e.g., providing information about historic heating patterns, energy usage, etc., that can be stored as part of the digital home representation) as well as digesters of home data (e.g., using the digital home representation of the home to generate elegant interfaces for navigating spaces in the home).

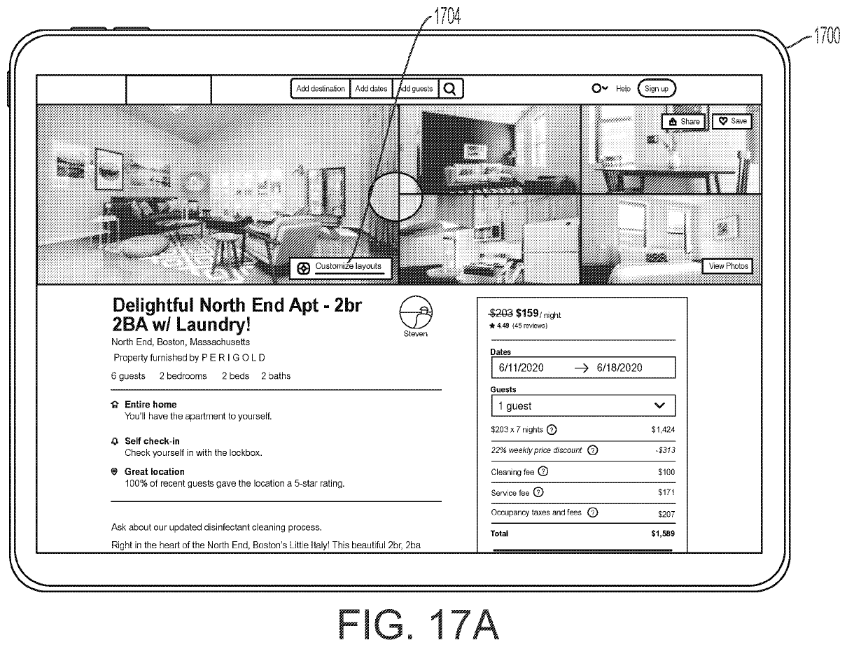

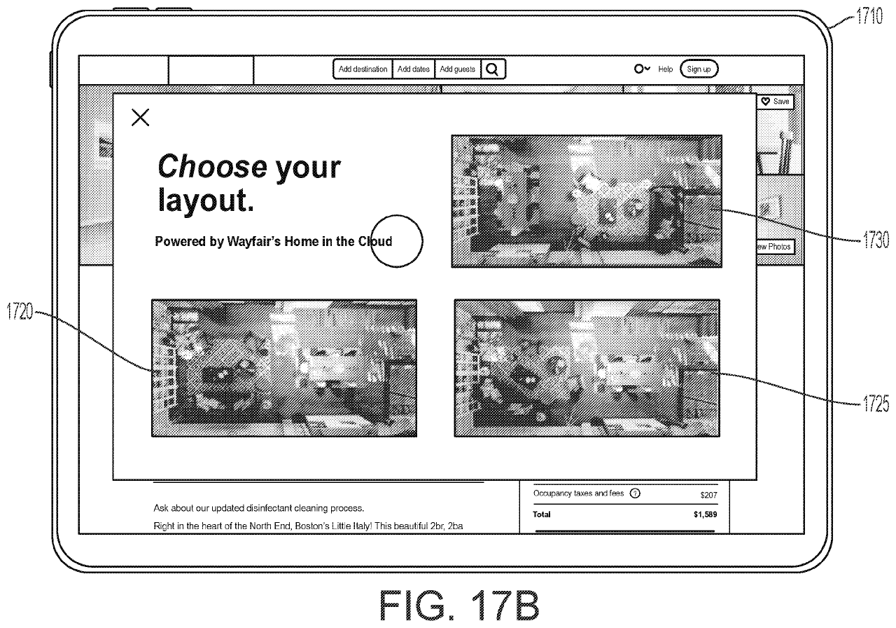

FIGS. 17A-17B are additional example screen captures of an interactive user interface that allow a user to collaborate with partner enterprises, according to some embodiments of the technology described herein. FIG. 17A illustrates an interactive user interface 1700 that allows a user to view and customize layouts of a home for a stay. For example, user selection of interface element 1704 may cause a number of layout options to be presented to the user.

In some embodiments, the digital representation of the home may be used to generate the various layout options. The system may generate a number of visualizations of the space using the spatial data, imagery and/or information about objects in a space. For example, FIG. 17B shows three different visualizations 1720, 1725, 1730 being presented to the user, each visualization indicating a different layout of objects in the space.

### Example Flow for Generating and Visualizing a Digital Representation of a Space of a Property

In some embodiments, spatial data of a space of a property may be obtained by performing a 3D scan of the space and/or 3D scan of one or more objects in the space using the client computing device 104a, 104b, . . . , 104n. Imagery and/or videos of the space or objects in the space may be collected as part of the 3D scan or as individual images or videos of the space or objects.

In some embodiments, the imagery and/or videos of the space or objects may be analyzed to identify one or more objects in the space, one or more characteristics of the objects in the space (e.g., position of objects in the space), and/or one or more characteristics of the space. For example, a first set of objects may be identified in a first space of the property and a second set of objects may be identified in a second space of the property, and so on.

In some embodiments, one or more products that correspond to the one or more identified objects may be identified using product information in product database 260. For example, a set of products corresponding to the first set of objects in the first space may be identified using product information in product database 260. Identifying the set of products may include comparing an image or 3D model of each object of the first set of objects with one or more images or 3D models of products in product database 260. Characteristics of the space and/or objects in the space may be used to focus the comparison to relevant products in the product database. For example, an image or 3D model of a particular type of identified object (e.g., couch) may be compared with images or 3D models of same type of product (e.g., couches) in the product database and/or products having the same style as the identified couch or the overall style of the space in which the identified couch is placed.

In some embodiments, for each object of the set of objects, a determination may be made regarding whether an image or 3D model of the object matches at least one of the one or more images or 3D models of the products in the product database. For example, a determination may be made regarding whether an image or 3D model of the couch in the space matches an image or 3D model of a couch in the product database.

In some embodiments, a product that matches or is similar to the object may be identified based on the comparing. For example, in response to a determination that an image or 3D model of the object matches at least one of the one or more images or 3D models of the products in the product database, the 3D model or image of the matching product may be identified and/or retrieved from the product database 260. In some embodiments, a determination that an image or 3D model of the object matches at least one of the one or more images or 3D models of the products in the product database may be made when there is an exact match between an image or 3D model of the object and an image or 3D model of a product. For example, an object in the space may be a sofa and the matching product from the product database may be exact same sofa.

In some embodiments, in response to a determination that an image or 3D model of the object does not match at least one of the one or more images or 3D models of the products in the product database, a 3D model or image of a product closest or most similar to the object may be identified and/or retrieved from the product database. In some embodiments, each object may have a set of characteristics (e.g., dimensions, style, color, texture of fabric, etc.) and similarity between an object and a product in the product database may be determined based on these characteristics. In some embodiments, a product may be considered similar to the object when one or more characteristics of the object and the product are within a certain similarity threshold. For example, an object in a space may be a sofa and a product with the same dimensions and style of the object may be considered similar to the sofa. As another example, an object in a space may be an oven and a product with the same dimensions and color may be considered similar to the oven. As yet another example, an object in a space may be a chair and a product with the same style, color and fabric selection may be considered similar to the chair. In some embodiments, a product and an object having at least a certain number of characteristics in common may be considered similar.

In some embodiments, a digital representation of the space may be generated based of the spatial data, the imagery, and/or information about objects in the space. The digital representation of the space may include one or more visualization layers associated with the space. Each visualization layer may include information that enables visualization of a different aspect of the space. For example, a visualization layer may include information that enables visualization of identified objects in the space. In some embodiments, the digital representation of the space may include information associated with the identified objects and for each identified object, information about the matched product or most similar product.

In some embodiments, generating the digital representation of the space may include populating the digital representation of the space with the images or 3D models of products from the product database. Populating the digital representation may include replacing or substituting the identified objects in digital representation of the space with 3D models or images of the matched or most similar products from the product database. In some embodiments, populating the digital representation may include updating an image of the space to include or creating a new version of the image that includes a tag or other identifier that includes information about the position of the object in the image and the product that matches or is most similar to the object. This information may be used to generate visualizations of the space where a 3D model or image of the product (e.g., matching or most similar product) is displayed instead of the object at the same position.

One or more visualizations of the space may be generated using the spatial data, imagery, and/or information about objects obtained from the digital representation of the space. The visualizations may be presented via an interactive user interface. For example, interactive user interface 600 being presented to the user may include visualizations 606a, 606b, 606c, 606d, 606e, 606f of spaces 607a, 607b, 607c, 607d, 607e, 607f in a home.

In some embodiments, generating one or more visualizations of the space may include displaying, for each particular object of the set of objects in the space, an image or 3D model of the corresponding product in the set of products, instead of the particular object. In some embodiments, generating one or more visualizations of the space may include generating the visualization(s) by substituting the object in the visualization with the image or 3D model of either the product that matches or is most similar to the object in the visualizations of FIG. 6, for example.

In some embodiments, the digital representation may include the substituted 3D models or images and the visualization may generated by including those substituted 3D models or images. In some embodiments, the digital representation may include a tag identifying the object to be substituted, the product that matches or is most similar the object, and the position of the object in the space, and the visualization may be generated by retrieving the 3D model or image of the product identified via the tag and including the retrieved 3D model or image in the visualization in the identified position.

It will be appreciated that the flow described above may be used to generate digital representations and/or visualizations of multiple spaces of the property and/or multiple objects in each of the multiple spaces of the property as aspects of the technology described herein are not limited in this respect.

### Example Computing Device

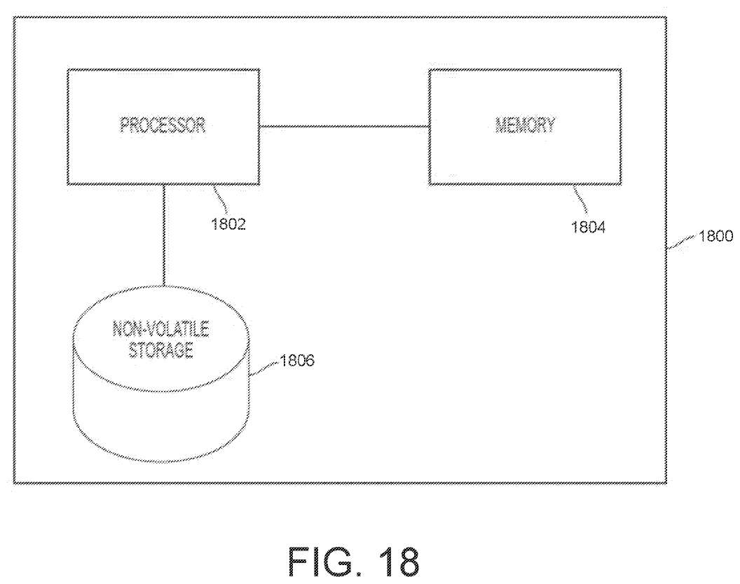

An illustrative implementation of a computing device 1800 that may be used in connection with any of the embodiments of the disclosure provided herein is shown in FIG. 18. The computing device 1800 may include one or more computer hardware processors 1802 and one or more articles of manufacture that comprise non-transitory computer-readable storage media (e.g., memory 1804 and one or more non-volatile storage devices 1806). The processor 1802(s) may control writing data to and reading data from the memory 1804 and the non-volatile storage device(s) 1806 in any suitable manner. To perform any of the functionality described herein, the processor(s) 1802 may execute one or more processor-executable instructions stored in one or more non-transitory computer-readable storage media (e.g., the memory 1804), which may serve as non-transitory computer-readable storage media storing processor-executable instructions for execution by the processor(s) 1802.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method, comprising:
using at least one computer hardware processor to perform:
accessing a digital representation of a property, the property comprising a plurality of spaces including a first space, the digital representation comprising multiple digital representations of multiple respective spaces in the plurality of spaces, the multiple digital representations including a first digital representation of the first space, the first digital representation comprising:
first spatial data specifying dimensions of the first space; and
first imagery associated with the first space; and
generating, using the digital representation of the property, an interactive user interface that allows a user to perform one or more actions with respect at least one of the multiple spaces, the generating comprising:
generating a visualization of the first space using the first spatial data and the first imagery; and
causing the interactive user interface to be presented to the user.

2. (canceled)

3. The method of claim 1, wherein the first spatial data comprises a three-dimensional (3D) representation of the first space.

4. (canceled)

5. The method of claim 1, wherein each of the multiple digital representations comprises data collected by performing a 3D scan of a respective one of the multiple spaces.

6. The method of claim 1, wherein:
the first imagery comprises one or more images of the first space obtained using one or more optical sensors or one or more synthetic images of the first space, the one or more synthetic images generated in accordance with the first spatial data.

7.-8. (canceled)

9. The method of claim 1, wherein:
the first digital representation of the first space comprises information specifying one or more positions of one or more objects in the first space,
the one or more objects include one or more pieces of furniture, one or more wall coverings, one or more floor coverings, one or more fixtures, and/or one or more appliances, and
the first spatial data comprises data obtained by performing a 3D scan of the one or more objects in the first space.

10.-11. (canceled)

12. The method of claim 9, wherein the first digital representation comprises metadata associated with a first object of the one or more objects, the metadata including information selected from the group consisting of:
information identifying the first object;
information identifying characteristics of the first object;
information containing feedback about the first object from one or more other users different from the user;
information indicating a price of the first object;
information indicating a source for the first object; and
information indicating one or more specifications for the first object.

13. The method of claim 1, wherein:
the digital representation of the property comprises:
a property profile comprising information associated with an address of the property, the property profile comprising the multiple digital representations of the multiple respective spaces; and
a user profile comprising metadata associated with an owner and/or an occupant of the property, and
accessing the digital representation of the property comprises:
obtaining authentication information for the user; and
determining, using the authentication information, whether the user is authorized to access the digital representation of the property.

14. The method of claim 1,
wherein the interactive user interface comprises an augmented reality (AR) interface or a virtual reality (VR) interface; and
wherein causing the interactive user interface to be presented to the user comprises causing the AR interface or the VR interface to be presented to the user.

15.-16. (canceled)

17. The method of claim 1, further comprising:
receiving, via the interactive user interface, user input indicating an update to be made to the digital representation of the property;
updating the digital representation of the property based on the user input; and
storing the updated digital representation.

18. The method of claim 17, wherein the update is to be made to the first digital representation of the first space in the property, wherein the update comprises an update to the first spatial data, wherein the update to the first spatial data comprises:
an update to the dimensions of the first space;
an update to 3D data for the first space;
an update to one or more positions of one or more objects in the first space; and/or
an indication to add a new object in the first space at a specified position.

19. (canceled)

20. The method of claim 17, wherein the update is to be made to the first digital representation of the first space in the property, wherein the update comprises an update to the first imagery, wherein the update to the first imagery comprises:
an indication to change an existing image of the first space to another image; and/or
an indication to include a new image of the first space in the first digital representation.

21. The method of claim 1,
wherein the interactive user interface comprises a product browsing interface that allows the user to see information about one or more products;
obtaining, based on first user input provided through the interactive user interface, an indication of a first product and a first position in the visualization of the first space at which to insert a visualization of the first product;
updating the visualization of the first space to include the visualization of the first product at the first position;
obtaining, based on second user input provided through the interactive user interface, an indication of a second product;
updating the visualization of the first space to include the visualization of the second product at the first position;
obtaining, based on third user input provided through the interactive user interface, an indication of a third product; and
updating the visualization of the first space to include the visualization of the third product at the first position.

22.-24. (canceled)

25. The method of claim 21, further comprising:
obtaining, via the interactive user interface, information indicating a position in the first space at which to place the first product when the first product is delivered to the property; and
obtaining, via the interactive user interface, information indicating at least a part of a path through the property that the first product is to be moved through in order to be delivered to the property and placed at the first position in the first space.

26.-27. (canceled)

28. The method of claim 21, further comprising:
identifying at least one product based on the first spatial data; and
providing information about the at least one product to the user via the product browsing interface,
wherein identifying the at least one product based on the first spatial data comprises:
identifying the at least one product based on the first spatial data associated with the first space and second spatial data associated with a second space different from the first space, the second spatial data specifying dimensions of the second space and/or dimensions of means of ingress and/or egress for entering and/or exiting the second space.

29.-30. (canceled)

31. The method of claim 21, further comprising:
identifying at least one product based on information about style of one or more objects in the first space; and
providing information about the at least one product to the user via the product browsing interface.

32. The method of claim 1, further comprising:
generating, using the digital representation of the property, a second interactive user interface for a second user, different from the user, the generating the second interactive user interface comprising:
generating a second visualization of the first space using the first spatial data and the first imagery; and
causing the second interactive user interface to be presented to the second user;
obtaining input provided by the second user via the second interactive user interface, the input indicative of information related to content of the second visualization; and
causing the information to be presented to the first user in the interactive user interface.

33.-34. (canceled)

35. The method of claim 32, further comprising:
obtaining input provided by the second user via the second interactive user interface, the input indicative of an action to perform with respect to the second visualization; and
updating the visualization at least in part by performing the action indicated in the input provided by the second user, wherein the action comprises one or more of:
an update to one or more positions of one or more pieces of furniture, fixtures, and/or appliances in the first space,
an addition of a new piece of furniture, a new fixture, and/or a new appliance in the first space at a specified position,
an update to one or more wall coverings or floor coverings in the first space, and
an update to a color of one or more walls in the first space.

36. (canceled)

37. The method of claim 32, wherein generating the second interactive user interface comprises:
generating a plurality of visualizations of the first space for the second user using the first spatial data and the first imagery, the plurality of visualizations including the second visualization, each of the plurality of visualizations indicating a different layout of objects in the first space.

38. (canceled)

39. A system, comprising:
at least one computer hardware processor; and
at least one non-transitory computer-readable storage medium storing processor-executable instructions that, when executed by the at least one computer hardware processor, cause the at least one computer hardware processor to perform:
accessing a digital representation of a property, the property comprising a plurality of spaces including a first space, the digital representation comprising multiple digital representations of multiple respective spaces in the plurality of spaces, the multiple digital representations including a first digital representation of the first space, the first digital representation comprising:
first spatial data specifying dimensions of the first space; and
first imagery associated with the first space; and
generating, using the digital representation of the property, an interactive user interface that allows a user to perform one or more actions with respect at least one of the multiple spaces, the generating comprising:
generating a visualization of the first space using the first spatial data and the first imagery; and
causing the interactive user interface to be presented to the user.

40. At least one non-transitory computer-readable storage medium storing processor-executable instructions that, when executed by at least one computer hardware processor, cause the at least one computer hardware processor to perform:
accessing a digital representation of a property, the property comprising a plurality of spaces including a first space, the digital representation comprising multiple digital representations of multiple respective spaces in the plurality of spaces, the multiple digital representations including a first digital representation of the first space, the first digital representation comprising:
first spatial data specifying dimensions of the first space; and
first imagery associated with the first space; and
generating, using the digital representation of the property, an interactive user interface that allows a user to perform one or more actions with respect at least one of the multiple spaces, the generating comprising:
generating a visualization of the first space using the first spatial data and the first imagery; and
causing the interactive user interface to be presented to the user.

41.-50. (canceled)
